(19) United States
(12) Patent Application Publication
(10) Pub. No.: US 2026/0121723 A1
(43) Pub. Date: Apr. 30, 2026

(54) SLOT OFFSETS FOR FEEDBACK TRANSMISSION

(71) Applicant: QUALCOMM Incorporated, San Diego, CA (US)

(72) Inventors: Morteza SOLTANI, San Diego, CA (US); Mostafa KHOSHNEVISAN, San Diego, CA (US); Jing SUN, San Diego, CA (US)

(21) Appl. No.: 18/926,096

(22) Filed: Oct. 24, 2024

(51) Int. Cl. H04B 7/06; H04L 1/1812; H04W 72/0446

(52) U.S. Cl. CPC H04B 7/063; H04L 1/1812; H04W 72/0446

(57) ABSTRACT

Various aspects of the present disclosure generally relate to wireless communication. In some aspects, a first network entity may receive, from a second network entity, first slot offset information and second slot offset information. The first network entity may receive, from the second network entity, a communication indicating that a feedback communication is to be transmitted during a time interval, wherein the communication indicates that the feedback communication is to be based on the first slot offset information. The first network entity may transmit, to the second network entity and during the time interval, the feedback communication, wherein the feedback communication includes feedback information that is based on the first slot offset information. Numerous other aspects are described.

### FIELD OF THE DISCLOSURE

Aspects of the present disclosure generally relate to wireless communication and specifically relate to techniques, apparatuses, and methods associated with slot offsets for feedback transmission.

### INTRODUCTION

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some aspects, a first network entity includes a processing system configured to: receive, from a second network entity, first slot offset information and second slot offset information; receive, from the second network entity, a communication indicating that a feedback communication is to be transmitted during a time interval, wherein the communication indicates that the feedback communication is to be based on the first slot offset information; and transmit, to the second network entity and during the time interval, the feedback communication, wherein the feedback communication includes feedback information that is based on the first slot offset information.

In some aspects, a first network entity includes a processing system configured to: receive slot offset information for one or more downlink time intervals, wherein the slot offset information indicates one or more uplink time intervals configured for feedback reporting for respective downlink time intervals of the one or more downlink time intervals; and transmit, during an uplink time interval of the one or more uplink time intervals, feedback information for at least one downlink time interval, of the one or more downlink time intervals, indicated by the slot offset information as being associated with the uplink time interval.

In some aspects, a first network entity includes a processing system configured to: transmit, to a second network entity, first slot offset information and second slot offset information; transmit, to the second network entity, a communication indicating that a feedback communication is to be transmitted during a time interval, wherein the communication indicates that the feedback communication is to be based on the first slot offset information; and receive, from the second network entity and during the time interval, the feedback communication, wherein the feedback communication includes feedback information that is based on the first slot offset information.

In some aspects, a first network entity includes a processing system configured to: transmit slot offset information for one or more downlink time intervals, wherein the slot offset information indicates one or more uplink time intervals configured for feedback reporting for respective downlink time intervals of the one or more downlink time intervals; and receive, during an uplink time interval of the one or more uplink time intervals, feedback information for at least one downlink time interval, of the one or more downlink time intervals, indicated by the slot offset information as being associated with the uplink time interval.

In some aspects, a method of wireless communication performed by a first network entity includes receiving, from a second network entity, first slot offset information and second slot offset information; receiving, from the second network entity, a communication indicating that a feedback communication is to be transmitted during a time interval, wherein the communication indicates that the feedback communication is to be based on the first slot offset information; and transmitting, to the second network entity and during the time interval, the feedback communication, wherein the feedback communication includes feedback information that is based on the first slot offset information.

In some aspects, a method of wireless communication performed by a first network entity includes transmitting, to a second network entity, first slot offset information and second slot offset information; transmitting, to the second network entity, a communication indicating that a feedback communication is to be transmitted during a time interval, wherein the communication indicates that the feedback communication is to be based on the first slot offset information; and receiving, from the second network entity and during the time interval, the feedback communication, wherein the feedback communication includes feedback information that is based on the first slot offset information.

In some aspects, a method of wireless communication performed by a first network entity includes receiving slot offset information for one or more downlink time intervals, wherein the slot offset information indicates one or more uplink time intervals configured for feedback reporting for respective downlink time intervals of the one or more downlink time intervals; and transmitting, during an uplink time interval of the one or more uplink time intervals, feedback information for at least one downlink time interval, of the one or more downlink time intervals, indicated by the slot offset information as being associated with the uplink time interval.

In some aspects, a method of wireless communication performed by a first network entity includes transmitting slot offset information for one or more downlink time intervals, wherein the slot offset information indicates one or more uplink time intervals configured for feedback reporting for respective downlink time intervals of the one or more downlink time intervals; and receiving, during an uplink time interval of the one or more uplink time intervals, feedback information for at least one downlink time interval, of the one or more downlink time intervals, indicated by the slot offset information as being associated with the uplink time interval.

In some aspects, a non-transitory computer-readable medium has code thereon that, when executed by one or more processors of a first network entity, causes the first network entity to: receive, from a second network entity, first slot offset information and second slot offset information; receive, from the second network entity, a communication indicating that a feedback communication is to be transmitted during a time interval, wherein the communication indicates that the feedback communication is to be based on the first slot offset information; and transmit, to the second network entity and during the time interval, the feedback communication, wherein the feedback communication includes feedback information that is based on the first slot offset information.

In some aspects, a non-transitory computer-readable medium has code thereon that, when executed by one or more processors of a first network entity, causes the first network entity to: transmit, to a second network entity, first slot offset information and second slot offset information; transmit, to the second network entity, a communication indicating that a feedback communication is to be transmitted during a time interval, wherein the communication indicates that the feedback communication is to be based on the first slot offset information; and receive, from the second network entity and during the time interval, the feedback communication, wherein the feedback communication includes feedback information that is based on the first slot offset information.

In some aspects, a non-transitory computer-readable medium has code thereon that, when executed by one or more processors of a first network entity, causes the first network entity to: receive slot offset information for one or more downlink time intervals, wherein the slot offset information indicates one or more uplink time intervals configured for feedback reporting for respective downlink time intervals of the one or more downlink time intervals; and transmit, during an uplink time interval of the one or more uplink time intervals, feedback information for at least one downlink time interval, of the one or more downlink time intervals, indicated by the slot offset information as being associated with the uplink time interval.

In some aspects, a non-transitory computer-readable medium has code thereon that, when executed by one or more processors of a first network entity, causes the first network entity to: transmit slot offset information for one or more downlink time intervals, wherein the slot offset information indicates one or more uplink time intervals configured for feedback reporting for respective downlink time intervals of the one or more downlink time intervals; and receive, during an uplink time interval of the one or more uplink time intervals, feedback information for at least one downlink time interval, of the one or more downlink time intervals, indicated by the slot offset information as being associated with the uplink time interval.

In some aspects, an apparatus for wireless communication includes means for receiving first slot offset information and second slot offset information; means for receiving a communication indicating that a feedback communication is to be transmitted during a time interval, wherein the communication indicates that the feedback communication is to be based on the first slot offset information; and means for transmitting, during the time interval, the feedback communication, wherein the feedback communication includes feedback information that is based on the first slot offset information.

In some aspects, an apparatus for wireless communication includes means for transmitting first slot offset information and second slot offset information; means for transmitting a communication indicating that a feedback communication is to be transmitted during a time interval, wherein the communication indicates that the feedback communication is to be based on the first slot offset information; and means for receiving, during the time interval, the feedback communication, wherein the feedback communication includes feedback information that is based on the first slot offset information.

In some aspects, an apparatus for wireless communication includes means for receiving slot offset information for one or more downlink time intervals, wherein the slot offset information indicates one or more uplink time intervals configured for feedback reporting for respective downlink time intervals of the one or more downlink time intervals; and means for transmitting, during an uplink time interval of the one or more uplink time intervals, feedback information for at least one downlink time interval, of the one or more downlink time intervals, indicated by the slot offset information as being associated with the uplink time interval.

In some aspects, an apparatus for wireless communication includes means for transmitting slot offset information for one or more downlink time intervals, wherein the slot offset information indicates one or more uplink time intervals configured for feedback reporting for respective downlink time intervals of the one or more downlink time intervals; and means for receiving, during an uplink time interval of the one or more uplink time intervals, feedback information for at least one downlink time interval, of the one or more downlink time intervals, indicated by the slot offset information as being associated with the uplink time interval.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

The appended drawings illustrate certain example aspects of this disclosure and are therefore not limiting in scope. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram illustrating an example of a wireless communication network, in accordance with the present disclosure.

FIG. 3 is a diagram illustrating an example disaggregated network node architecture, in accordance with the present disclosure.

FIG. 4 is a diagram illustrating an example of a time domain resource allocation, in accordance with the present disclosure.

FIG. 5 is a diagram illustrating an example of a hybrid automatic repeat request (HARQ) codebook transmissions, in accordance with the present disclosure.

FIG. 6 is a diagram of an example associated with slot offsets for feedback transmission, in accordance with the present disclosure.

FIG. 7 is a diagram of an example associated with slot offsets for feedback transmission with respect to an uplink carrier, in accordance with the present disclosure.

FIG. 8 is a diagram of an example associated with slot offsets for feedback transmission with respect to a downlink carrier, in accordance with the present disclosure.

FIG. 9 is a diagram illustrating an example process performed, for example, at a first network entity or an apparatus of a first network entity, in accordance with the present disclosure.

FIG. 10 is a diagram illustrating an example process performed, for example, at a first network entity or an apparatus of a first network entity, in accordance with the present disclosure.

FIG. 11 is a diagram illustrating an example process performed, for example, at a first network entity or an apparatus of a first network entity, in accordance with the present disclosure.

FIG. 12 is a diagram illustrating an example process performed, for example, at a first network entity or an apparatus of a first network entity, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. The scope of the disclosure covers any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure covers an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A medium access control (MAC) layer of a protocol stack may implement a hybrid automatic repeat request (HARQ) protocol to provide a faster retransmission mechanism relative to other retransmission mechanisms, such as a radio link control (RLC) layer retransmission system. In some examples, the HARQ protocol may include a transmitting device using a retransmission protocol in combination with a receiving device, such as a send and wait (SAW) protocol that enables the receiving device to recover and/or correct data errors in a first HARQ process without hindering data transmissions in a second HARQ process. Accordingly, multiple HARQ processes may operate in parallel, and data errors identified in the first HARQ process may not hinder transmissions in the second HARQ process. Some non-limiting examples of transmitting device-receiving device pairs that may implement a HARQ process in combination may include a network node and a user equipment (UE) (e.g., a downlink HARQ process), a UE and a network node (e.g., an uplink HARQ process), and/or a first UE and a second UE (e.g., a sidelink HARQ process). Thus, a HARQ process may be used for downlink communications, uplink communications, and/or sidelink communications. In some examples, and as part of a HARQ process, a network node may transmit information in DCI that indicates, to a receiving device (e.g., a UE), which downlink transmission(s) and/or which uplink transmissions to process using a HARQ protocol. Additionally, or alternatively, and as part of the HARQ process, a first UE may transmit information in sidelink control information (SCI) that indicates, to a second UE, which sidelink transmission(s) to process using the HARQ protocol.

HARQ combines forward error correction (FEC) and automatic repeat request (ARQ) techniques to more effectively detect and correct transmission errors. In this context, HARQ codebooks are critical for maintaining efficient communication by storing the states of transmission blocks requiring acknowledgments. A HARQ codebook may be a structured set of information used in wireless communication systems to manage and schedule the acknowledgment (ACK) and negative acknowledgment (NACK) feedback for HARQ processes, thereby facilitating efficient error correction and data retransmission. In the context of feedback information (e.g., HARQ feedback), “codebook” refers to a set of one or more (e.g., a matrix of one or more) feedback indications (e.g., ACK or NACK indications) that can be transmitted via a single transmission (e.g., a single uplink transmission). In some cases, a network entity (e.g., a UE) may support HARQ feedback codebook transmissions. A HARQ feedback codebook transmission may include a feedback message that the network entity is to transmit to another network entity to provide feedback regarding, for example, downlink data transmission (for example, transmissions associated with a downlink channel). As used herein, a codebook may be a sequence of bits, which may be constructed using ACK/NACK feedback associated with multiple communications (e.g., multiple downlink communications) that are received by a network entity during a feedback window.

HARQ codebooks can be categorized into different types based on functional attributes and applications. One of the categories is a Type 1 HARQ ACK codebook (e.g., configured via a HARQ-ACK-codebook=semi-static information element). A UE may be configured with different types of codebooks, such as the Type-1 HARQ ACK codebook or a Type 2 HARQ ACK codebook. For example, the Type-1 HARQ ACK codebook may be associated with a fixed, or static, size (for example, that is configured by a network node). The Type 2 HARQ ACK codebook may be associated with a dynamic size (for example, where the size of the Type 2 HARQ ACK codebook is based at least in part on, or otherwise associated with, scheduling received by the UE). Typically, if the UE is configured to transmit a Type 1 HARQ ACK codebook, the UE may collect feedback for PDSCH communications that are received by the UE during a feedback window (for example, k slots), and the UE may transmit the Type-1 HARQ ACK codebook indicating feedback (for example, ACK/NACK feedback) associated with the PDSCH communications that are received by the UE during the feedback window.

A Type 1 HARQ ACK codebook (e.g., a Type 1 codebook or a Type 1 HARQ codebook) may be a semi-static codebook that has a fixed size. For example, the size of a Type 1 HARQ ACK codebook may be fixed regardless of actual scheduling or resource allocation for the receiver. For example, scheduling information (or configuration information) may indicate a slot offset (sometimes referred to as a K1 value indicated by a PDSCH-to-HARQ_feedback timing indicator field in DCI) that is indicative of a time interval (e.g., a slot) during which the Type 1 HARQ ACK codebook is to be transmitted. The slot offset may be indicative of (e.g., may define) a feedback window for the Type 1 HARQ ACK codebook. A size of the Type 1 HARQ ACK codebook may be based on the slot offset (e.g., the feedback window). For example, the slot offset may indicate one or more candidate occasions during which a communication may be scheduled. The Type 1 HARQ ACK codebook may have a size to accommodate a feedback indication (e.g., HARQ information) for each candidate occasion. The Type 1 HARQ ACK codebook may be configured with a fixed set of slot offsets (K1 values) for scheduling HARQ-ACK feedback. This fixed structure simplifies the management of feedback timing by predefining the possible response windows for received downlink data, ensuring timely and efficient error correction. This fixed K1 set is indicative of the feedback timing slots for ACK/NACK messages following the downlink data reception.

However, such static configuration (e.g., static size) of Type 1 HARQ ACK codebooks can result in signaling inefficiencies. For example, the Type 1 HARQ ACK codebook may have a size that enables feedback to be indicated in each transmission occasion (e.g., slot, symbol, transmission time interval, or another time interval) during a feedback window, where the feedback window is defined, or indicated, by the configured slot offsets (e.g., K1 set) for the Type 1 HARQ ACK codebook. As an example, a network entity (e.g., a UE) may receive control information indicating that the network entity is to transmit a first Type 1 HARQ ACK codebook in a first time interval (e.g., a first uplink time interval, such as an uplink slot) for a feedback window that includes a set of one or more downlink time intervals. The network entity may transmit the first Type 1 HARQ ACK codebook indicating feedback information (e.g., HARQ information, such as ACK or NACK indications for respective downlink time intervals). The network entity may receive second control information indicating that the network entity is to transmit a second Type 1 HARQ ACK codebook in a second time interval (e.g., a second uplink time interval) that occurs shortly after the first time interval. For example, the second control information may indicate that the network entity is to transmit a second Type 1 HARQ ACK codebook in a next available uplink time interval, which may be the second time interval. In such examples, the feedback window for the second Type 1 HARQ ACK codebook may at least partially overlap with the feedback window for the first Type 1 HARQ ACK codebook. In other words, because of the fixed size of the Type 1 HARQ ACK codebooks, each of the first Type 1 HARQ ACK codebook and the second HARQ ACK codebook may include information (e.g., bits) for some of the same downlink time intervals. For example, the second Type 1 HARQ ACK codebook may include fields or bits for indicating feedback for one or more downlink time intervals for which the first Type 1 HARQ ACK codebook has already indicated feedback information. In such examples, the network entity may include NACK indications (e.g., in the second Type 1 HARQ ACK codebook) for the one or more downlink time intervals for which the first Type 1 HARQ ACK codebook has already indicated feedback information because of the fixed size of the second Type 1 HARQ ACK codebook and because the first Type 1 HARQ ACK codebook has already indicated feedback information for these downlink time intervals. As a result, the transmission of the second Type 1 HARQ ACK codebook may result in inefficient resource utilization by including information (e.g., bits) corresponding to one or more downlink time intervals for which the first Type 1 HARQ ACK codebook has already indicated feedback information.

As described above, the configuration of HARQ ACK feedback timing is often based on preconfigured and static slot offsets, which are typically defined with respect to an uplink frame structure or component carrier structure via which the HARQ ACK feedback is to be transmitted (e.g., a physical uplink control channel (PUCCH) component carrier). However, this results in a lack of flexibility for a network node to indicate, or configure, when feedback is to be transmitted for a particular downlink time interval in a downlink frame structure or component carrier structure. The lack of flexibility may be problematic when dealing with dynamic scheduling requirements, particularly in time division duplex (TDD) configurations. For example, the feedback window for a Type 1 HARQ ACK codebook may be indicated or defined with respect to the uplink frame structure or component carrier structure, the network node may be unable to configure or indicate that feedback information for different downlink time intervals (e.g., that would occur during the feedback window) can be transmitted during different uplink time intervals.

Various aspects relate generally to enhancing slot offset information for feedback transmissions, such as Type 1 HARQ ACK codebook transmissions. Some aspects more specifically relate to a first network entity transmitting, and a second network entity receiving, configuration information that indicates multiple sets of slot offset information (e.g., multiple K1 sets) for a semi-static HARQ ACK codebook, such as the Type 1 HARQ ACK codebook. The multiple sets of slot offset information may indicate different quantities of slot offsets. The first network entity may transmit, and the second network entity may receive, a communication indicating that a feedback communication is to be transmitted during a time interval. The communication may indicate that the feedback communication is to be based on the first slot offset information from the multiple sets of slot offset information. The second network entity may transmit, and the first network entity may receive, the feedback communication during the time interval. The feedback communication may include feedback information that is based on the first slot offset information.

Particular aspects of the subject matter described in this disclosure can be implemented to realize one or more of the following potential advantages. In some aspects, the described techniques can be used to provide flexibility for scheduling semi-static HARQ ACK codebook transmissions. This improves the resource utilization efficiency of the semi-static HARQ ACK codebook transmissions. For example, for a semi-static HARQ ACK codebook transmission that is to be transmitted relatively soon after a downlink time interval (or an uplink time interval), control information scheduling the semi-static HARQ ACK codebook transmission may indicate that the semi-static HARQ ACK codebook transmission is to be associated with slot offset information indicating relatively fewer slot offsets (e.g., as compared to other slot offset information configured for the semi-static HARQ ACK codebook). As a result, the semi-static HARQ ACK codebook transmission may have a smaller size (e.g., that is based on the slot offset information indicating relatively fewer slot offsets) while still including feedback information for the downlink time interval (or an uplink time interval). By the first network entity configuring multiple sets of slot offset information, semi-static HARQ ACK codebook transmissions may be more flexibly configured and/or scheduled (e.g., having different sizes based on the multiple sets of slot offset information), thereby improving the resource utilization efficiency of the semi-static HARQ ACK codebook transmissions. Additionally, enabling the first network entity and the second network entity to use flexible semi-static HARQ ACK codebook transmissions reduces signaling overhead that may otherwise be associated with configuring and/or indicating other types of HARQ ACK codebooks, such as a Type 2 HARQ ACK codebook.

In some aspects, the slot offset information (e.g., the multiple sets of slot offset information) may be for one or more downlink time intervals. For example, the slot offset information may indicate one or more uplink time intervals configured for feedback reporting for respective downlink time intervals of the one or more downlink time intervals. In other words, one or more slot offsets (e.g., a K1 set) may be configured for respective downlink time intervals (e.g., respective downlink slots). The second network entity may transmit, and the first network entity may receive, feedback information for at least one downlink time interval, of the one or more downlink time intervals, indicated by the slot offset information as being associated with the uplink time interval. By the first network entity configuring slot offset information (e.g., a K1 set) for particular downlink time intervals (e.g., with respect to a downlink component carrier), the first network entity may have improved flexibility for configuring different downlink time intervals to be associated with different uplink time intervals for feedback transmissions.

Various aspects of the disclosure are described more fully hereinafter with reference to the accompanying drawings. This disclosure may, however, be embodied in many different forms and is not limited to any specific structure, function, example, aspect, or the like presented throughout this disclosure. This disclosure includes, for example, any aspect disclosed herein, whether implemented independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, network entity, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

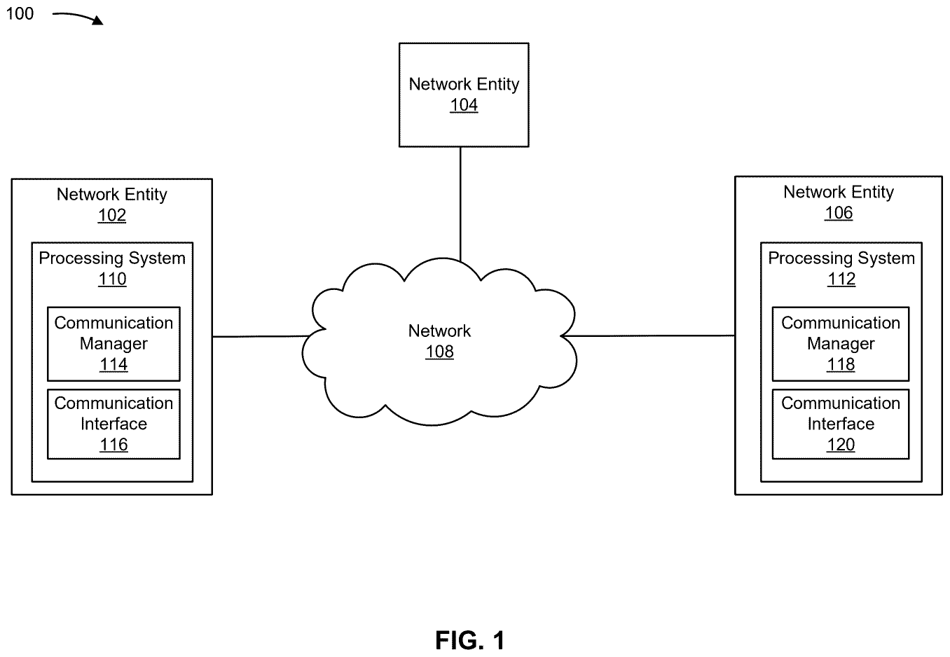

FIG. 1 is a diagram illustrating an example environment 100 in which apparatuses and/or methods described herein may be implemented, in accordance with the present disclosure. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary and/or mobile. The network 108 may include wired communication connections, wireless communication connections, or a combination of wired and wireless communication connections.

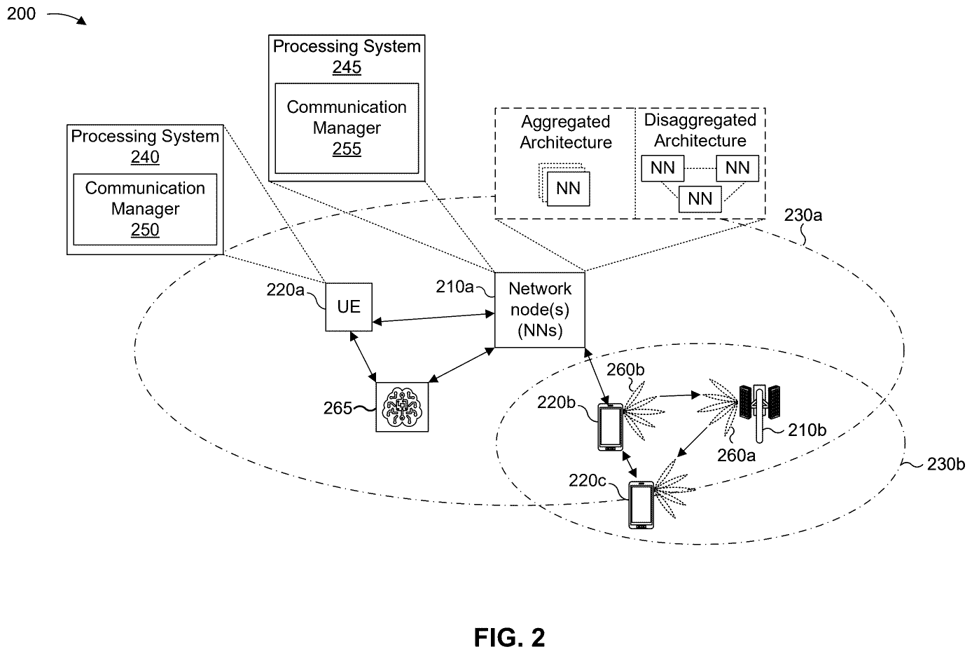

The network 108 may include, for example, a cellular network (e.g., a Long-Term Evolution (LTE) network, a CDMA network, a 4G network, a 5G network, a 6G network, or another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a RedCap device, an enhanced reduced capability (eRedCap) device, an ambient IoT device, an energy harvesting (EH)-capable device, a network controller, an apparatus, a device, a computing system, an integrated access and backhaul (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently operating in the network. Rather, a network entity may be any entity that is capable of communicating and/or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 and/or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 and/or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, and/or a transceiver, among other examples. For example, a communication interface may include one or more transceivers, one or more receivers, and/or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, and/or a modulation component, among other examples.

A communication interface may include a transmission component and/or a reception component. For example, a communication interface may include a transceiver and/or one or more separate receivers and/or transmitters that enable a network entity to communicate with other devices, such as via a wired connection, a wireless connection, or a combination of wired and wireless connections. In some examples, a communication interface may include one or more radio frequency reflective elements and/or one or more radio frequency refractive elements. The communication interface may enable the network entity to receive information from another apparatus and/or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

As described herein, a network entity (e.g., the network entity 102 and/or the network entity 106) may be configured to perform one or more operations. Reference to a network entity being configured to perform one or more operations may refer to a processing system of the network entity being configured to perform the one or more operations and/or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, and/or at least one communication interface, among other examples, that are configured to perform one or more (or all) of the one or more operations, and/or any combination thereof. Where reference is made to the network entity and/or the processing system being configured to perform operations, the network entity and/or the processing system may be configured to cause one component to perform all operations, or to cause more than one component to collectively perform the operations. When the network entity and/or the processing system is configured to cause more than one component to collectively perform the operations, each operation need not be performed by each of those components (e.g., different operations may be performed by different components) and/or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 and/or the communication interface 116 to) receive, from a second network entity, first slot offset information and second slot offset information; receive, from the second network entity, a communication indicating that a feedback communication is to be transmitted during a time interval, wherein the communication indicates that the feedback communication is to be based on the first slot offset information; and/or transmit, to the second network entity and during the time interval, the feedback communication, wherein the feedback communication includes feedback information that is based on the first slot offset information. Additionally, or alternatively, the network entity 102 may (e.g., the processing system 110 may, or the processing system 110 may cause the communication manager 114 and/or the communication interface 116 to) receive slot offset information for one or more downlink time intervals, wherein the slot offset information indicates one or more uplink time intervals configured for feedback reporting for respective downlink time intervals of the one or more downlink time intervals; and/or transmit, during an uplink time interval of the one or more uplink time intervals, feedback information for at least one downlink time interval, of the one or more downlink time intervals, indicated by the slot offset information as being associated with the uplink time interval. Additionally, or alternatively, the network entity 102 and/or the communication manager 114 may perform one or more other operations described herein.

As described in more detail elsewhere herein, the network entity 106 may (e.g., the processing system 112 may, or the processing system 112 may cause the communication manager 114 and/or the communication interface 116 to) transmit, to a second network entity, first slot offset information and second slot offset information; transmit, to the second network entity, a communication indicating that a feedback communication is to be transmitted during a time interval, wherein the communication indicates that the feedback communication is to be based on the first slot offset information; and/or receive, from the second network entity and during the time interval, the feedback communication, wherein the feedback communication includes feedback information that is based on the first slot offset information. Additionally, or alternatively, the network entity 106 may (e.g., the processing system 112 may, or the processing system 112 may cause the communication manager 114 and/or the communication interface 116 to) transmit slot offset information for one or more downlink time intervals, wherein the slot offset information indicates one or more uplink time intervals configured for feedback reporting for respective downlink time intervals of the one or more downlink time intervals; and/or receive, during an uplink time interval of the one or more uplink time intervals, feedback information for at least one downlink time interval, of the one or more downlink time intervals, indicated by the slot offset information as being associated with the uplink time interval. Additionally, or alternatively, the network entity 106 and/or the communication manager 118 may perform one or more other operations described herein.

The number and arrangement of entities shown in FIG. 1 are provided as one or more examples. In practice, there may be additional network entities and/or networks, fewer network entities and/or networks, different network entities and/or networks, or differently arranged network entities and/or networks than those shown in FIG. 1. Furthermore, the network entity 102, 104, and 106 may be implemented using a single apparatus or multiple apparatuses.

FIG. 2 is a diagram illustrating an example of a wireless communication network 200, in accordance with the present disclosure. The wireless communication network 200 may be or may include elements of a 5G (or NR) network or a 6G network, among other examples. The wireless communication network 200 may include multiple network nodes 210. For example, in FIG. 2, the wireless communication network 200 includes a network node (NN) 210a and a network node 210b. The network nodes 210 may support communications with multiple UEs 220. For example, in FIG. 2, the network nodes 210 support communication with a UE 220a, a UE 220b, and a UE 220c. In some examples, a UE 220 may also communicate with other UEs 220 and a network node 210 may communicate with a core network and with other network nodes 210.

The network nodes 210 and the UEs 220 of the wireless communication network 200 may communicate using the electromagnetic spectrum, which may be subdivided by frequency or wavelength into various classes, bands, carriers, and/or channels. For example, devices of the wireless communication network 200 may communicate using one or more operating bands. In some aspects, multiple wireless communication networks 200 may be deployed in a given geographic area. Each wireless communication network 200 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 200 may implement dynamic spectrum sharing (DSS), in which multiple RATs are implemented with dynamic bandwidth allocation (for example, based on user demand) in a single frequency band. In some examples, the wireless communication network 200 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz”band in some documents and articles.

Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 210 and/or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system, such as a processing system 240 of the UE 220 or a processing system 245 of the network node 210. The processing system 240 and the processing system 245 may be similar to other processing systems described herein, such as the processing system 110 and the processing system 112. A processing system (for example, the processing system 240 and/or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor”or collectively as “the processor”or “the processor circuitry”).

Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 and/or the processing system 245 include or implement one or more of the modems. The processing system 240 and the processing system 245 may also include or be coupled with multiple radios (collectively “the radio”), multiple RF chains, or multiple transceivers, each of which may in turn be coupled with one or more of multiple antennas. In some examples, one or more processors of the processing system 240 and/or the processing system 245 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 240 of the UE 220 or by the processing system 245 of the network node 210).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 210 and the UE 220.

A network node 210 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may consist of a single standalone base station or a single TRP that operates with a full radio protocol stack to enable or facilitate communication between a UE 220 and a core network of the wireless communication network 200.

Alternatively, and as also shown, a network node 210 may be a disaggregated network node (sometimes referred to as a disaggregated base station), having a disaggregated architecture, meaning that the network node 210 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 210 may be used in an IAB network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 210 of the wireless communication network 200 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of an RLC layer, a MAC layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 210 (for example, a base station, an RU, or a TRP) may provide communication coverage for a particular geographic area. The term “cell” can refer to a coverage area of a network node 210 or to a network node 210 itself, depending on the context in which the term is used. A network node 210 may support one or more cells (for example, each cell may support communication within an angular (for example, 60 degree) range around the network node). In some examples, a network node 210 may provide communication coverage for a macro cell, a pico cell, a femto cell, or another type of cell. A macro cell may cover a relatively large geographic area (for example, several kilometers in radius) and may allow unrestricted access by UEs 220 with associated service subscriptions. A pico cell may cover a relatively small geographic area and may also allow unrestricted access by UEs 220 with associated service subscriptions. A femto cell may cover a relatively small geographic area (for example, a home) and may allow restricted access by UEs 220 having association with the femto cell (for example, UEs 220 in a closed subscriber group (CSG)). In some examples, a cell may not necessarily be stationary. For example, the geographic area of the cell may move according to the location of an associated mobile network node 210 (for example, a train, a satellite, an unmanned aerial vehicle, or an NTN network node).

The wireless communication network 200 may be a heterogeneous network that includes network nodes 210 of different types, such as macro network nodes, pico network nodes, femto network nodes, relay network nodes, aggregated network nodes, and/or disaggregated network nodes, among other examples. Various different types of network nodes 210 may generally transmit at different power levels, serve different coverage areas (for example, a cell 230a and a cell 230b), and/or have different impacts on interference in the wireless communication network 200 than other types of network nodes 210.

The UEs 220 may be physically dispersed throughout the coverage area of the wireless communication network 200, and each UE 220 may be stationary or mobile. A UE 220 may be, may include, or may also be referred to as an access terminal, a mobile station, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 220 may be classified according to different categories in association with different complexities and/or different capabilities. UEs 220 in a first category may facilitate massive IoT in the wireless communication network 200, and may offer low complexity and/or cost relative to UEs 220 in a second category. UEs 220 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 200, among other examples. A third category of UEs 220 may have mid-tier complexity and/or capability (for example, a capability between that of the UEs 220 of the first category and that of the UEs 220 of the second capability). A UE 220 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) and/or reconfigured (for example, in real-time or near-real-time) according to changing network conditions in the wireless communication network 200 and/or specific requirements of one or more UEs 220. An active BWP defines the operating bandwidth of the UE 220 within the operating bandwidth of the serving cell. The use of BWPs enables more efficient use of the available frequency domain resources in the wireless communication network 200 because fewer frequency domain resources may be allocated to a BWP for a UE 220 (which may reduce the quantity of frequency domain resources that a UE 220 is required to monitor and reduce UE power consumption by enabling the UE to monitor fewer frequency domain resources), leaving more frequency domain resources to be spread across multiple UEs 220. Thus, BWPs may also assist in the implementation of lower-capability (for example, RedCap) UEs 220 by facilitating the configuration of smaller bandwidths for communication by such UEs 220 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 220) from a network node 210 to a UE 220. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include PUCCHs, and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ ACK indication or a HARQ NACK indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220. The network node 210 may transmit, to the UE 220, an indication of the selected MCS for the downlink signal, such as via DCI that schedules the downlink signal. As another example, the network node 210 may transmit, and the UE 220 may receive, an indication of an MCS to be applied for the one or more uplink signals, such as via DCI scheduling transmission of the one or more uplink signals.

The network node 210 or the UE 220 (such as by using the processing system 245 or the processing system 240, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 210 or the UE 220 (for example, using the processing system 245 or the processing system 240, respectively, and/or one or more coupled encoders or modems) may perform a channel coding operation or an FEC operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 and/or one or more modems) may further perform spatial processing (for example, precoding) on the encoded information to generate one or more processed or precoded signals for downlink or uplink transmission, respectively. In some examples, the network node 210 or the UE 220 may perform codebook-based precoding or non-codebook-based precoding. Codebook-based precoding may involve selecting a precoder (for example, a precoding matrix) using a codebook. For example, the network node 210 may provide precoding information indicating which precoder, defined by the codebook, is to be used by the UE 220. Non-codebook-based precoding may involve selecting or deriving a precoder based on, or otherwise associated with, one or more downlink or uplink signal measurements. The network node 210 or the UE 220 may transmit the processed downlink or uplink signals, respectively, via one or more antennas.

The network node 210 or the UE 220 may receive uplink signals or downlink signals, respectively, via one or more antennas. The network node 210 or the UE 220 (for example, using the processing system 245 or the processing system 240, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 210 or the UE 220 via the downlink or uplink signals. The network node 210 or the UE 220 (for example, using the processing system 245 or the processing system 240, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 220 and a network node 210 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 210 and/or UE 220 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 210b may generate one or more beams 260a, and the UE 220b may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 210 and/or at the UE 220, such as in a network implementing mmWave technology. Massive MIMO may improve communication reliability by enabling a network node 210 and/or a UE 220 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 210 and the UE 220 may perform one or more beam management operations, such as an initial beam acquisition operation, one or more beam refinement operations, and/or a beam recovery operation. For example, an initial beam acquisition operation may involve the network node 210 transmitting signals (for example, SSBs, CSI-RSs, or other signals) via respective beams (for example, of the beams 260a of the network node 210) and the UE 220 receiving and measuring the signal(s) via respective beams of multiple beams (for example, from the beams 260b of the UE 220) to identify a best beam (or beam pair) for communication between the UE 220 and the network node 210. For example, the UE 220 may transmit an indication (for example, in a message associated with a random access channel (RACH) operation) of a (best) identified beam of the network node 210 (for example, by indicating an SSBRI or other identifier associated with the beam). A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 210 and the UE 220 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 265 (for example, a network node 210 and/or UEs 220). For example, the one or more devices 265 may include a UE 220 (for example, the processing system 240), a network node 210 (for example, the processing system 245), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 220 and a second portion of the AI/ML model may be deployed at a network node 210). In other examples, a first AI/ML model may be deployed at a UE 220 and a second AI/ML model may be deployed at a network node 210. The AI/ML model(s) may be configured to enhance various aspects of the wireless communication network 200. For example, the AI/ML model(s) may be trained to identify patterns or relationships in data corresponding to the wireless communication network 200, a device, and/or an air interface, among other examples. The AI/ML model(s) may support operational decisions relating to one or more aspects associated with wireless communications devices, networks, or services.

In some aspects, the UE 220 may include a communication manager 250. As described in more detail elsewhere herein, the communication manager 250 may receive, from a second network entity, first slot offset information and second slot offset information; receive, from the second network entity, a communication indicating that a feedback communication is to be transmitted during a time interval, wherein the communication indicates that the feedback communication is to be based on the first slot offset information; and/or transmit, to the second network entity and during the time interval, the feedback communication, wherein the feedback communication includes feedback information that is based on the first slot offset information. Additionally, or alternatively, the communication manager 250 may receive slot offset information for one or more downlink time intervals, wherein the slot offset information indicates one or more uplink time intervals configured for feedback reporting for respective downlink time intervals of the one or more downlink time intervals; and/or transmit, during an uplink time interval of the one or more uplink time intervals, feedback information for at least one downlink time interval, of the one or more downlink time intervals, indicated by the slot offset information as being associated with the uplink time interval. Additionally, or alternatively, the communication manager 250 may perform one or more other operations described herein.

In some aspects, the network node 210 may include a communication manager 255. As described in more detail elsewhere herein, the communication manager 255 may transmit, to a second network entity, first slot offset information and second slot offset information; transmit, to the second network entity, a communication indicating that a feedback communication is to be transmitted during a time interval, wherein the communication indicates that the feedback communication is to be based on the first slot offset information; and/or receive, from the second network entity and during the time interval, the feedback communication, wherein the feedback communication includes feedback information that is based on the first slot offset information. Additionally, or alternatively, the communication manager 255 may transmit slot offset information for one or more downlink time intervals, wherein the slot offset information indicates one or more uplink time intervals configured for feedback reporting for respective downlink time intervals of the one or more downlink time intervals; and/or receive, during an uplink time interval of the one or more uplink time intervals, feedback information for at least one downlink time interval, of the one or more downlink time intervals, indicated by the slot offset information as being associated with the uplink time interval. Additionally, or alternatively, the communication manager 250 may perform one or more other operations described herein.

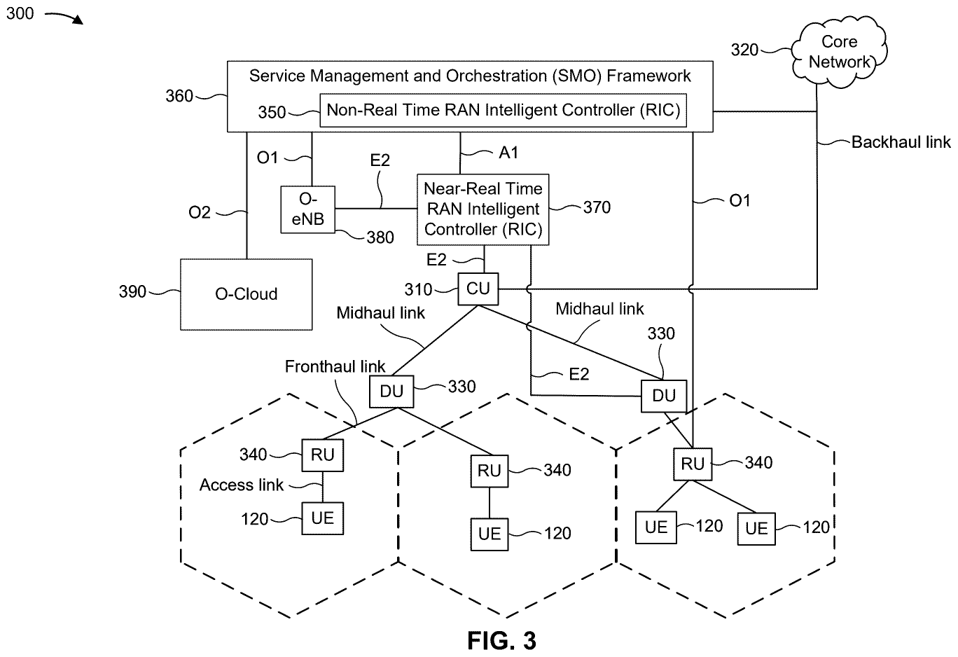

FIG. 3 is a diagram illustrating an example disaggregated network node architecture 300, in accordance with the present disclosure. One or more components of the example disaggregated network node architecture 300 may be, may include, or may be included in one or more network nodes (such one or more network nodes 210). The disaggregated network node architecture 300 may include a CU 310 that can communicate directly with a core network 320 via a backhaul link, or that can communicate indirectly with the core network 320 via one or more disaggregated control units, such as a non-real-time (Non-RT) RAN intelligent controller (RIC) 350 associated with a Service Management and Orchestration (SMO) Framework 360 and/or a near-real-time (Near-RT) RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 220 via respective RF access links. In some deployments, a UE 220 may be simultaneously served by multiple RUs 340.

Each of the components of the disaggregated network node architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB 380 with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

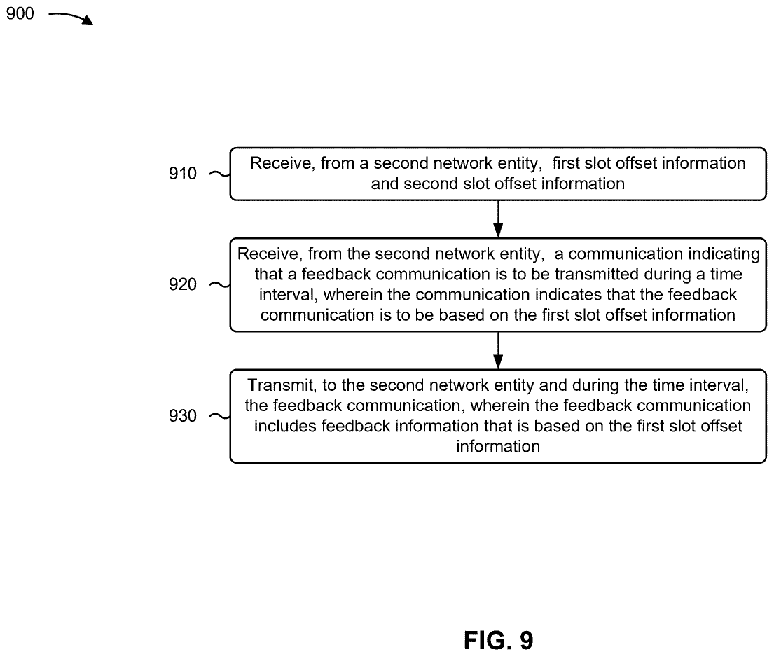

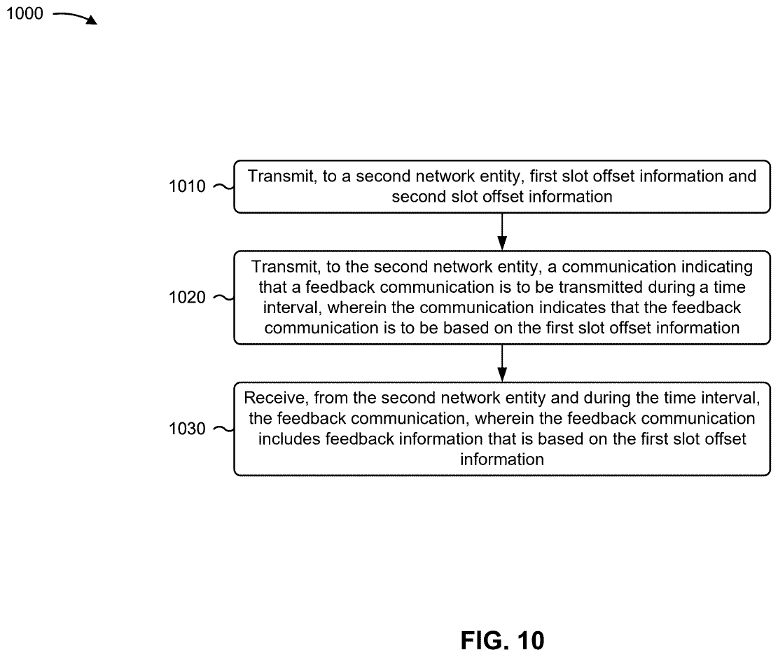

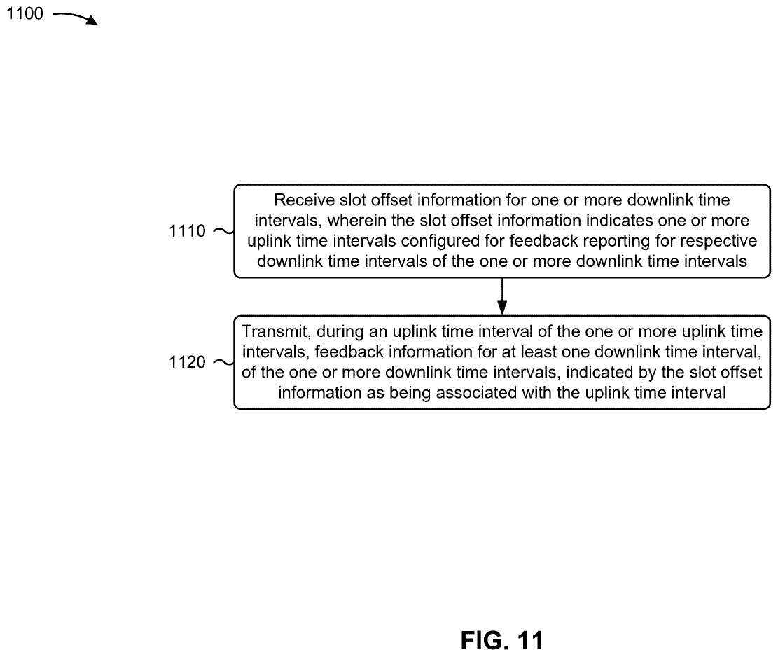

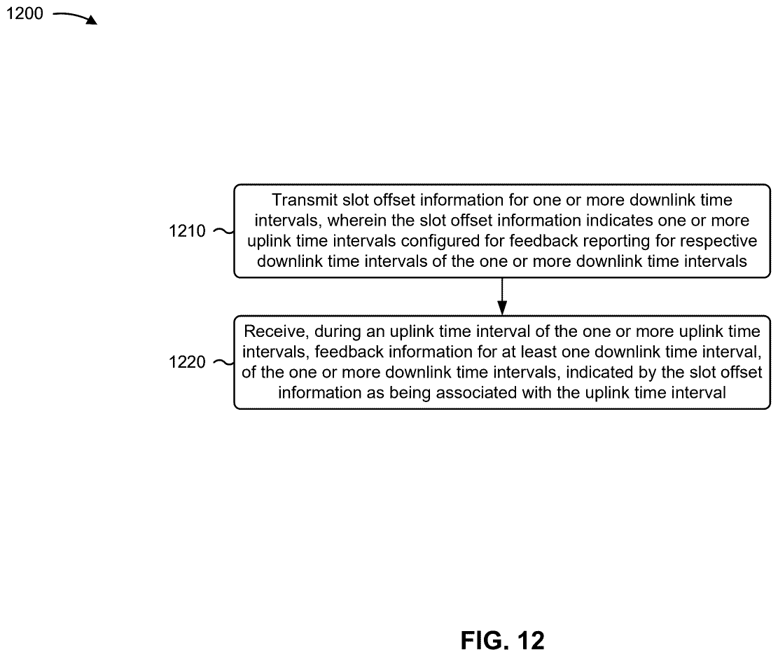

The network entity 102, the processing system 110 of the network entity 102, the network entity 106, the processing system 112 of the network entity 106, the network node 210, the processing system 245 of the network node 210, the UE 220, the processing system 240 of the UE 220, the CU 310, the DU 330, the RU 340, or any other component(s) of FIGS. 1-3 may implement one or more techniques or perform one or more operations associated with slot offsets for feedback transmissions, as described in more detail elsewhere herein. For example, the processing system 110 of the network entity 102, the processing system 112 of the network entity 106, the processing system 245 of the network node 210, the processing system 240 of the UE 220, the CU 310, the DU 330, or the RU 340 may perform or direct operations of, for example, process 900 of FIG. 9, process 1000 of FIG. 10, process 1100 of FIG. 11, process 1200 of FIG. 12, or other processes as described herein (alone or in conjunction with one or more other processors). Memory of the network node 210 may store data and program code (or instructions) for the network node 210, the CU 310, the DU 330, or the RU 340. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, the UE 220, the CU 310, the DU 330, or the RU 340, may cause the one or more processors to perform process 900 of FIG. 9, process 1000 of FIG. 10, process 1100 of FIG. 11, process 1200 of FIG. 12, or other processes as described herein. In some examples, executing instructions may include running the instructions, converting the instructions, compiling the instructions, and/or interpreting the instructions, among other examples.

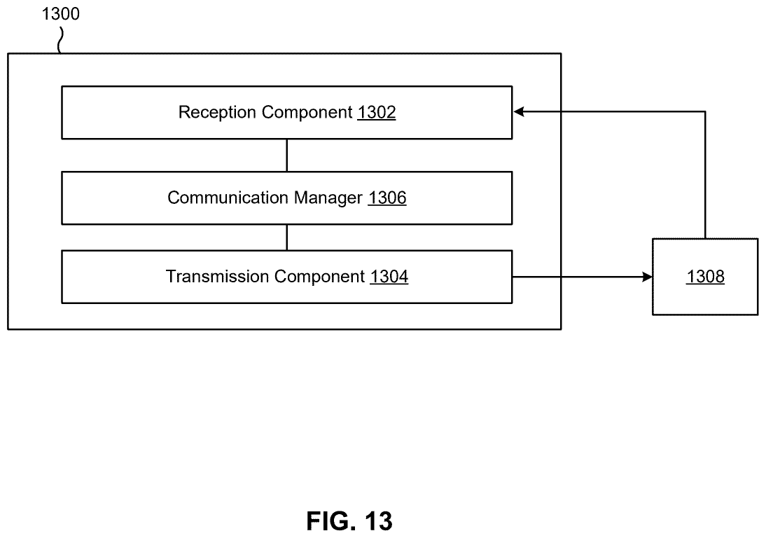

In some aspects, a first network entity includes means for receiving, from a second network entity, first slot offset information and second slot offset information; means for receiving, from the second network entity, a communication indicating that a feedback communication is to be transmitted during a time interval, wherein the communication indicates that the feedback communication is to be based on the first slot offset information; and/or means for transmitting, to the second network entity and during the time interval, the feedback communication, wherein the feedback communication includes feedback information that is based on the first slot offset information. In some aspects, the first network entity includes means for receiving slot offset information for one or more downlink time intervals, wherein the slot offset information indicates one or more uplink time intervals configured for feedback reporting for respective downlink time intervals of the one or more downlink time intervals; and/or means for transmitting, during an uplink time interval of the one or more uplink time intervals, feedback information for at least one downlink time interval, of the one or more downlink time intervals, indicated by the slot offset information as being associated with the uplink time interval. In some aspects, the means for the first network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 1302 depicted and described in connection with FIG. 13) and/or a transmission component (for example, transmission component 1304 depicted and described in connection with FIG. 13), among other examples.

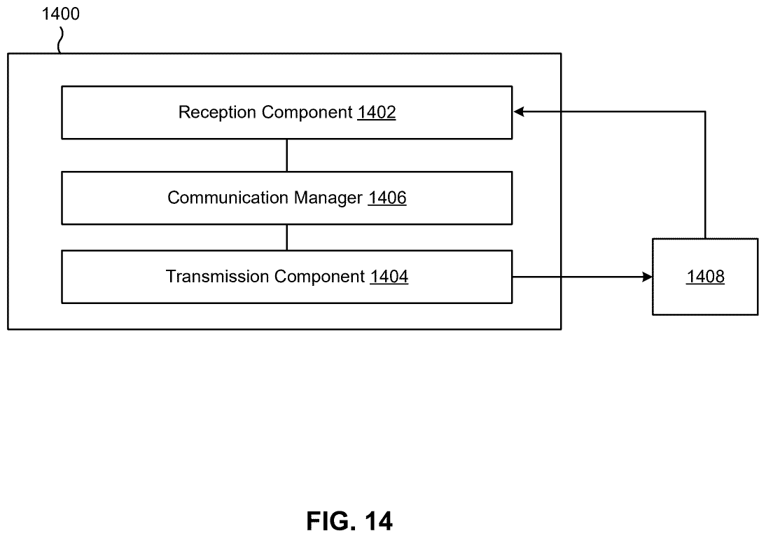

In some aspects, a first network entity includes means for transmitting, to a second network entity, first slot offset information and second slot offset information; means for transmitting, to the second network entity, a communication indicating that a feedback communication is to be transmitted during a time interval, wherein the communication indicates that the feedback communication is to be based on the first slot offset information; and/or means for receiving, from the second network entity and during the time interval, the feedback communication, wherein the feedback communication includes feedback information that is based on the first slot offset information. In some aspects, the first network entity includes means for transmitting slot offset information for one or more downlink time intervals, wherein the slot offset information indicates one or more uplink time intervals configured for feedback reporting for respective downlink time intervals of the one or more downlink time intervals; and/or means for receiving, during an uplink time interval of the one or more uplink time intervals, feedback information for at least one downlink time interval, of the one or more downlink time intervals, indicated by the slot offset information as being associated with the uplink time interval. In some aspects, the means for the first network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1402 depicted and described in connection with FIG. 14), and/or a transmission component (for example, transmission component 1404 depicted and described in connection with FIG. 14), among other examples.

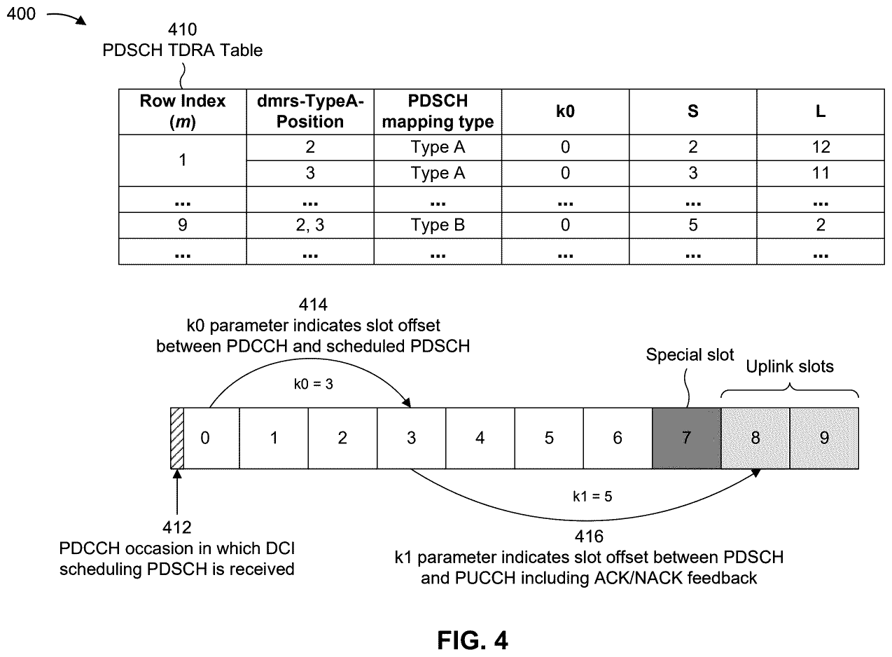

FIG. 4 is a diagram illustrating an example 400 of a time domain resource allocation (TDRA), in accordance with the present disclosure. FIG. 4 shows an example downlink TDRA table 410. The downlink TDRA table 410 may be, for example, a PDSCH TDRA table. In some examples, a network node 210 and the UE 220 may use different TDRA tables than shown in FIG. 4, such as for different configurations, different cells, and/or different sub-carrier spacings of cells.

When scheduling a downlink communication or an uplink communication, a network node 210 may transmit a PDCCH transmission carrying DCI that indicates a TDRA for the downlink or uplink communication. For example, the DCI may include a TDRA field that includes a TDRA index value. The TDRA index value may indicate a row index of a corresponding TDRA table, and the row index may correspond to a set of TDRA parameters (sometimes referred to as scheduling parameters or scheduling information). The network node 210 and the UE 220 may use the TDRA parameters in the corresponding row index for the downlink or uplink communication scheduled via the DCI. In the example shown in FIG. 4, a TDRA index value of m in the DCI may correspond to a row index of m+1 in the TDRA table. For example, a TDRA index value of 0 may correspond to a row index of 1.

As shown in FIG. 4, for a downlink communication (e.g., a PDSCH communication), the TDRA parameters may include, for example, a K₀ value, an S value, and an L value. The K₀ value may represent a timing offset (e.g., in number of slots) between a slot containing the scheduling DCI (carrying a grant that schedules the PDSCH communication) and a slot containing the scheduled PDSCH communication (scheduled via the scheduling DCI). For example, as shown in FIG. 4, and by reference number 412, the UE 220 may receive DCI scheduling a PDSCH in a PDCCH monitoring occasion of slot number 0, and a value of the K₀ parameter may indicate the slot in which the UE 220 can expect to receive the PDSCH transmission scheduled via the DCI. For example, as shown by reference number 414, the UE 220 may expect to receive the PDSCH transmission in slot number 3 based on receiving the scheduling DCI in slot number 0 with the K₀ parameter indicating a timing offset of three slots. The S value may represent a starting symbol for the PDSCH transmission in the indicated slot. The L value may represent a length (e.g., a number of consecutive symbols) of the PDSCH transmission (e.g., in the indicated slot). In some examples, the S value and the L value may collectively be referred to as a start and length indicator value (SLIV). In some examples, the same row index value may correspond to a different set of TDRA parameters depending on a Type A DMRS position (e.g., a symbol within a resource block that contains the DMRS) and/or a PDSCH mapping type (e.g., indicating a starting symbol of the DMRS, a length of the DMRS, and/or whether slot-based scheduling or mini-slot-based scheduling is used).

Furthermore, in some examples, a K₁ parameter may be used to indicate a timing offset between the PDSCH transmission scheduled via the DCI and a slot in which the UE 220 is to transmit a PUCCH transmission that carries feedback information (e.g., ACK/NACK feedback for the PDSCH transmission), such as a HARQ ACK codebook transmission. For example, as shown by reference number 416, the UE 220 may be expected to receive a PDSCH transmission in slot number 3 based on the value of the K₀ parameter, and may transmit a PUCCH transmission that carries a HARQ ACK codebook for the PDSCH transmission in slot number 8 based on the K₁ parameter indicating a timing offset of five slots from the slot in which the PDSCH transmission is scheduled (e.g., slot number 3 in the illustrated example). In examples where a PDCCH transmission contains a multi-PDSCH grant, the K₁ parameter may be counted from the slot in which the last granted PDSCH transmission is scheduled. If the numerology of a downlink carrier and an uplink carrier are different (e.g., if an SCS of a PDSCH carrier and a PUCCH carrier are different), then the K₁ parameter may be counted with respect to the numerology of the uplink carrier. In such examples, the reference slot (e.g., from which the K₁ parameter may be counted) may be the last uplink slot that overlaps with the downlinks lot in which the PDSCH transmission (or PDCCH transmission) carrying the information scheduling the feedback transmission is received.

Accordingly, various timing offsets may be used in a wireless network to indicate a timing offset between a PDCCH transmission, a PDSCH transmission, a PUCCH, and/or a PUSCH transmission. For example, as described above, a K₀ parameter may indicate a timing offset (or slot offset) between a slot in which a PDCCH transmission is received and a slot in which a PDSCH transmission granted by the PDCCH transmission is scheduled, a K₁ parameter may indicate a timing offset between the slot in which the PDSCH transmission is scheduled and a slot in which a UE is to transmit ACK/NACK feedback for the PDSCH transmission, and/or a K₂ parameter may indicate a timing offset between a slot in which a PDCCH transmission is received and a slot in which a PUSCH transmission granted by the PDCCH transmission is scheduled. In general, the K₀, K₁, and/or K₂ parameters may be determined based on a TDRA field in the scheduling DCI. For example, the TDRA field may have a value that indicates a row index in an RRC-configured TDRA table, and the indicated row index may include a value for the K₀, K₁, and/or K₂ parameter (e.g., depending on whether the DCI schedules a PDSCH and/or a PUSCH). However, in some cases, the UE 220 may receive a PDCCH transmission that schedules a PDSCH transmission and/or a PUSCH transmission before receiving an RRC configuration. In such examples, the UE 220 may determine the value(s) of the K₀, K₁, and/or K₂ parameters from a default set of values indicated in a default TDRA table. In some examples, when a DCI format other than DCI format 1_0 schedules a PDSCH transmission or a semi-persistent scheduling (SPS) release, the K₁ parameter may be determined by a PDSCH-to-HARQ feedback timing indicator field in the scheduling DCI, which may map to a value for the K₁ parameter that is provided by a configured parameter (e.g., dl-DataToUL-ACK, or dl-DataToUL-ACKForDCIFormat1_2 for DCI format 1_2) that can have a value in a range from zero to fifteen, among other examples. Furthermore, in the PUSCH default TDRA table, the K₂ parameter may have a value of j, j+1, j+2, or j+3, where j is one for a subcarrier spacing of 15 kilohertz (kHz), one for a subcarrier spacing of 30 kHz, two for a subcarrier spacing of 60 kHz, or three for a subcarrier spacing of 120 kHz.

In some examples, a HARQ ACK codebook may be used to provide ACK/NACK feedback corresponding to multiple downlink slots (e.g., multiple PDSCHs), and thus the HARQ ACK codebook may be based at least in part on multiple K₁ values, each associated with a corresponding downlink slot.

In some cases, the UE 220 may support HARQ feedback codebook transmissions (for example, at least for multicast services with a quality of service (QoS) requirement). A HARQ feedback codebook transmission may include a feedback message that the UE 220 is to transmit to the network node 210 to provide feedback regarding, for example, downlink data transmission (for example, transmissions associated with a PDSCH). For example, the UE 220 may be configured to transmit HARQ codebook transmissions (for example, corresponding to one or more HARQ process identifiers).

The UE 220 may be configured with different types of codebooks, such as a Type 1 HARQ ACK codebook, a Type 2 HARQ ACK codebook, or a Type 3 HARQ ACK codebook, among other examples. The Type 1 HARQ ACK codebook may be referred to herein as a “semi-static HARQ feedback codebook.” The Type 2 HARQ ACK codebook may be referred to as a “dynamic HARQ feedback codebook.” For example, the Type 1 HARQ ACK codebook may be associated with a fixed, or static, size (for example, that is configured by the network node 210, such as via slot offset information or a K1 set). The slot offset information (e.g., the K1 set from which a K₁ value may be indicated for a particular grant) may be indicated by an RRC parameter, such as the dl-DataToUL-ACK parameter, or the dl-DataToUL-ACKForDCIFormat1_2 parameter. The Type-2 HARQ ACK codebook may be associated with a dynamic size (for example, where the size of the Type 2 HARQ ACK codebook is based at least in part on, or otherwise associated with, scheduling received by the UE 220). Additional details regarding some HARQ ACK codebooks can be found in, for example, 3GPP Technical Specification (TS) 38.213, Release (Rel.) 18, Version 18.4.0, such as in Section 9.1. Another type of HARQ ACK codebook that the UE 220 may support is an enhanced Type 3 HARQ ACK codebook, which may have a smaller size relative to other HARQ ACK codebooks.

A codebook may be a sequence of bits, which may be constructed using ACK/NACK feedback associated with multiple PDSCH communications that are received by the UE 220 during a feedback window. For Type 1 HARQ ACK codebooks, typically, if the UE 220 is configured to transmit a Type 1 HARQ ACK codebook, the UE 220 may collect feedback for PDSCH communications that are received by the UE 220 during a feedback window (for example, k slots), and may transmit the Type 1 HARQ ACK codebook indicating the feedback information (for example, ACK/NACK feedback) associated with the PDSCH communications that are received by the UE 220 during the feedback window. As described above, the Type 1 HARQ ACK codebook may have a static or fixed size. Therefore, in some cases, if a small quantity of PDSCH communications are received during the feedback window, transmitting the Type 1 HARQ ACK codebook may consume significant resources (for example, time resources or frequency resources) because the Type 1 HARQ ACK codebook has a fixed sized regardless of the quantity of PDSCH communications that are received by the UE during the feedback window. For example, a total size of a Type 1 HARQ ACK codebook may be equal to the sum of downlink transmission occasions (e.g., PDSCH occasions) for a given time window, where the time window is defined or indicated by the configured slot offset information (e.g., the configured K1 set). The sum of downlink transmission occasions may account for multiple PDSCH transmissions in a single slot, multiple PDSCH transmissions across multiple slots, multiple PDSCH transmissions across component carriers, multiple TBs for a specific PDSCH transmission, and/or multiple code block groups (CBGs) for each TB.

As indicated above, FIG. 4 is provided as an example. Other examples may differ from what is described with regard to FIG. 4.

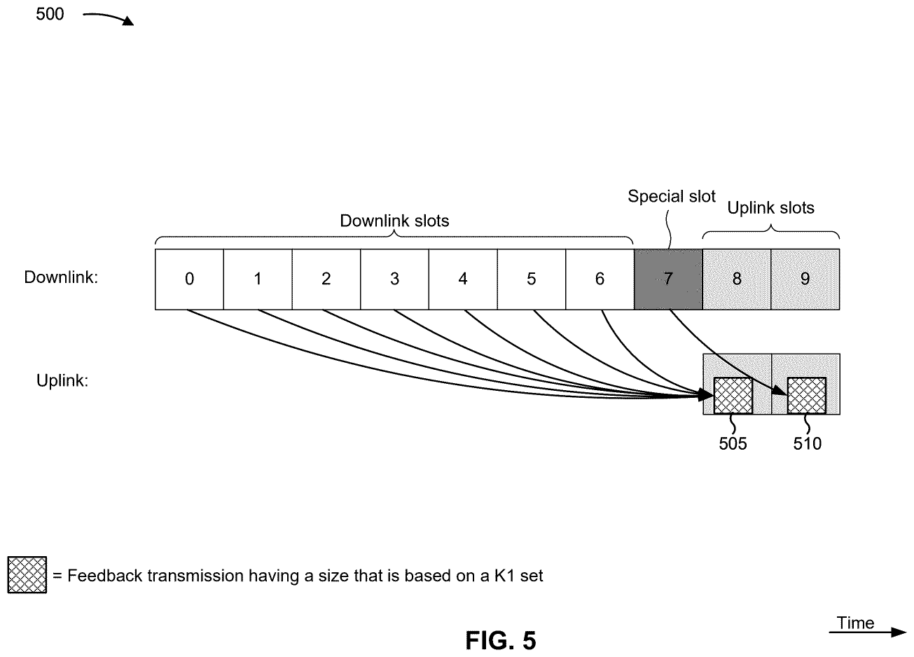

FIG. 5 is a diagram illustrating an example 500 of a HARQ codebook transmissions, in accordance with the present disclosure.

As described elsewhere herein, slot offset information may be configured for semi-static HARQ ACK codebook transmissions. For example, for Type 1 HARQ ACK codebook transmissions, a network node may configure slot offset information (e.g., a K1 set) that indicates one or more slot offsets (e.g., one or more values of the K₁ parameter as described in connection with FIG. 4) that can be indicated by control information (e.g., DCI) scheduling a Type 1 HARQ ACK codebook transmission. The slot offset information may be indicative of a set of candidate downlink (e.g., PDSCH) reception occasions. The set of candidate downlink reception occasions may be determined by the UE for each configured downlink serving cell (e.g., each configured downlink component carrier). For example, if only a DCI 1_0 format is configured for the UE, then the slot offset information may indicate slot offsets of {1, 2, 3, 4, 5, 6, 7, 8}. In such examples, each Type 1 HARQ ACK codebook transmission may include fields (e.g., bits) for indicating feedback information (e.g., an ACK indication or a NACK indication) for each candidate downlink reception occasion within a feedback window defined by the slot offset information. In other examples, an RRC parameter (e.g., the dl-DataToUL-ACK parameter or the dl-DataToUL-ACKForDCIFormat1_2 parameter) may configure or indicate the slot offset information, such as when a DCI 1_1 format or a DCI 1_2 format is configured for the serving cell. The Type 1 HARQ ACK codebook transmission may be generated or formed to include as many bits as needed to accommodate (e.g., indicate) feedback information for each potential downlink reception (e.g., from the candidate downlink reception occasions).

For example, downlink reception occasions that overlap with uplink time intervals may not be counted as a potential downlink reception. The remaining candidate downlink reception occasions may be considered potential downlink receptions and the UE may generate the Type 1 HARQ ACK codebook having a size that enables the UE to indicate feedback information for each of the potential downlink receptions. As a result, the size of the Type 1 HARQ ACK codebook may be a function of the slot offset information (e.g., the K1 set) which defines the set of candidate downlink reception occasions, where the potential downlink receptions include the candidate downlink reception occasions with any candidate downlink reception occasions that overlap with uplink time intervals removed.

As shown in FIG. 5, a frame structure or slot structure (e.g., for a downlink carrier) may include one or more downlink slots, one or more special slots, and/or one or more uplink slots. A downlink slot may be a slot configured for downlink transmissions, an uplink slot may be a slot configured for uplink transmissions, and a special slot may be dynamically indicated or configured for either downlink transmissions or uplink transmissions. In the example 500, the special slot (slot 7) shown in FIG. 5 may be used for downlink transmissions.

Although some aspects are described herein using a slot as an example time interval, the aspects and techniques described herein may be similarly applied to any time interval. The time interval may also be referred to as a time unit. For example, a time interval may include a frame, a subframe, a slot, a mini-slot (e.g., one or more symbols), a symbol (e.g., an OFDM symbol), a transmission time interval (TTI), a scheduling unit, and/or another time unit. For example, a slot described herein may be a frame, a subframe, a slot, a mini-slot (e.g., one or more symbols), a symbol (e.g., an OFDM symbol), a TTI, and/or a scheduling unit, in other examples.

For example, as shown in FIG. 5, two semi-static HARQ ACK codebook transmissions may be scheduled or transmitted, shown as a feedback transmission 505 and a feedback transmission 510. Because both the feedback transmission 505 and the feedback transmission 510 are associated with the same type of codebook (e.g., the Type 1 HARQ ACK codebook), both the feedback transmission 505 and the feedback transmission 510 are associated with the same slot offset information (e.g., the same K1 set). In some examples, control information (e.g., DCI) may indicate that the feedback transmission 505 is to be transmitted during the uplink slot 8 shown in FIG. 5, such as via a K₁ parameter indicated by the control information. The feedback transmission 505 may include a Type 1 HARQ ACK codebook having a size that is based on the slot offset information (e.g., the K1 set). For example, if the K1 set is {8, 7, 6, 5, 4, 3, 2}, then the feedback transmission 505 may include seven bits, such as for the downlink slots 0 through 6 shown in FIG. 5.

As shown in FIG. 5, control information (e.g., DCI) may indicate that the feedback transmission 510 is to be transmitted during the uplink slot 9. For example, DCI scheduling a downlink transmission during the special slot 7 may indicate that semi-static HARQ feedback is to be provided for the downlink transmission in a next available uplink slot, which may be the uplink slot 9. Because the feedback transmission 510 is associated with a semi-static HARQ ACK codebook, the UE may generate the feedback transmission 510 to have a size that is based on the slot offset information (e.g., the K1 set). For example, similar to the feedback transmission 505, the feedback transmission 510 may include seven bits (e.g., if the K1 set is {8, 7, 6, 5, 4, 3, 2}) corresponding to the downlink slots 1 through 6 and the special slot 7.

However, because the feedback transmission 505 already indicated the feedback from the downlink slots 1 through 6, the UE may insert NACK indications for bits in the feedback transmission 510 corresponding to the downlink slots 1 through 6 (e.g., as placeholders or as a means to fill in the bits generated for the Type 1 HARQ ACK codebook). For example, the only feedback information that a network node may obtain from the feedback transmission 510 may be for the special slot 7. However, the feedback transmission 510 may still include the seven bits as defined by the slot offset information (e.g., the K1 set) configured for Type 1 HARQ ACK codebooks.

This problem may be exacerbated when multiple component carriers are configured for the UE (e.g., increasing the quantity of potential downlink receptions) and/or where a downlink carrier is configured with a different numerology than the uplink carrier. For example, if an SCS for the downlink carrier is greater than the SCS for the uplink carrier, this may result in more candidate downlink occasions being included in the feedback window indicated by the slot offset information because the slot offsets are counted with respective to the SCS of the uplink carrier. When the SCS for the uplink carrier is smaller (e.g., 30 kHz vs. 120 kHz for the downlink carrier), a slot in the uplink carrier may have a relatively longer duration than a slot in the downlink carrier, resulting in multiple downlink slots being included in the duration of a single uplink slot in the uplink carrier. This may increase the quantity of potential downlink receptions as indicated by the slot offset information, further increasing the size of the Type 1 HARQ ACK feedback transmission and further degrading the resource utilization efficiency.

As indicated above, FIG. 5 is provided as an example. Other examples may differ from what is described with regard to FIG. 5.

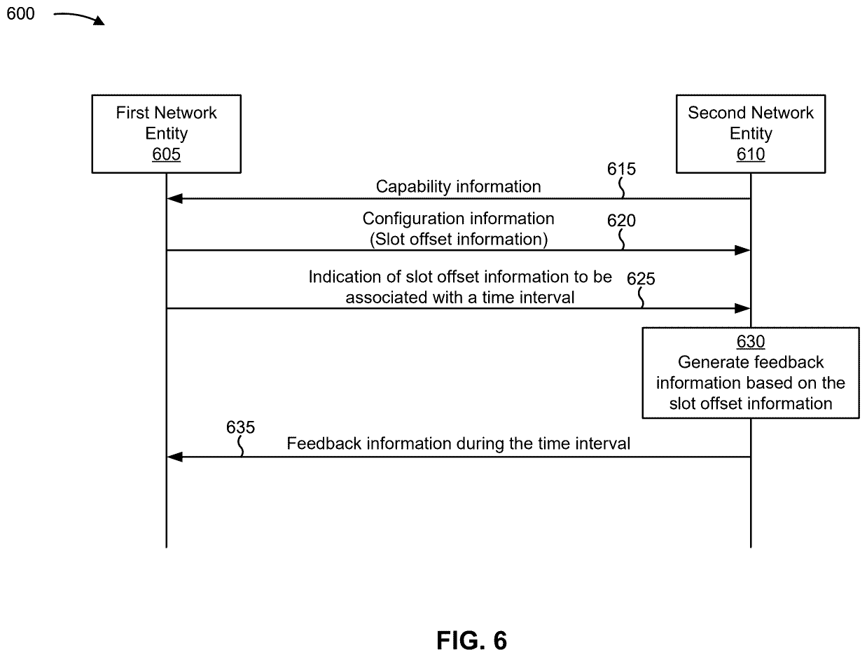

FIG. 6 is a diagram of an example 600 associated with slot offsets for feedback transmission, in accordance with the present disclosure. As shown in FIG. 6, a first network entity 605 (e.g., the network entity 102, the network entity 104, the network entity 106, the network node 210, a base station, a CU, a DU, and/or an RU) may communicate with a second network entity 610 (e.g., the network entity 102, the network entity 104, the network entity 106, and/or the UE 220). In some aspects, the first network entity 605 and the second network entity 610 may be part of a wireless network (e.g., the wireless communication network 200 or the environment 100).

As used herein, the first network entity 605 “outputting” or “transmitting” a communication to the second network entity 610 may refer to a direct transmission (for example, from the first network entity 605 to the second network entity 610) or an indirect transmission via one or more other network nodes or devices, such as one or more TRPs or access nodes. For example, if the first network entity 605 is a DU or an access node controller, an indirect transmission to the second network entity 610 may include the first network entity 605 outputting or transmitting a communication to an RU (e.g., an access node or a TRP) and the RU transmitting the communication to the second network entity 610, or may include causing the RU to transmit the communication (e.g., triggering transmission of a physical layer reference signal). Similarly, the second network entity 610 “transmitting” a communication to the first network entity 605 may refer to a direct transmission (for example, from the second network entity 610 to the first network entity 605) or an indirect transmission via one or more other network nodes or devices, such as one or more TRPs or access nodes. For example, if the first network entity 605 is a DU or an access node controller, an indirect transmission to the first network entity 605 may include the second network entity 610 transmitting a communication to an RU (e.g., a TRP or an access node) and the RU transmitting the communication to the first network entity 605. Similarly, the first network entity 605 “obtaining” or “receiving” a communication may refer to receiving a transmission carrying the communication directly (for example, from the second network entity 610 to the first network entity 605) or receiving the communication (or information derived from reception of the communication) via one or more other network nodes or devices, such as one or more TRPs or access nodes.

In some aspects, as shown by reference number 615, the second network entity 610 may optionally transmit, and the first network entity 605 may receive, capability information. The capability information may be included in a capability report. The second network entity 610 may transmit the capability information via an uplink communication, a sidelink communication, a unicast communication, a broadcast communication, a UE assistance information (UAI) communication, a UCI communication, an SCI communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the second network entity 610. The one or more parameters may be indicated via respective information elements (IEs) included in a capability report.

The capability information may indicate whether the second network entity 610 supports a feature and/or one or more parameters related to the feature. For example, the capability information may indicate a capability and/or parameter for supporting multiple sets of slot offset information being indicated or configured for semi-static HARQ ACK codebooks (e.g., a Type 1 HARQ ACK codebook). In some examples, the capability information may indicate a capability and/or parameter for supporting multiple K1 sets being configured as part of a Type 1 HARQ ACK codebook configuration. One or more operations described herein may be based on capability information. For example, the second network entity 610 may perform a communication in accordance with the capability information, or may receive configuration information that is in accordance with the capability information.

The first network entity 605 may determine configuration information for the second network entity based on the capability information. For example, the first network entity 605 may determine that the second network entity 610 is to be configured with multiple sets of slot offset information based on the capability information indicating that the second network entity 610 supports multiple sets of slot offset information for a given HARQ ACK codebook type. In other examples, the first network entity 605 may determine the configuration information without, or independent of, the capability information. For example, the first network entity 605 may determine that the second network entity 610 supports multiple sets of slot offset information for a given HARQ ACK codebook type as described herein based on a type, category, or other classification of the second network entity 610.

As shown by reference number 620, the first network entity 605 may transmit, and the second network entity 610 may receive, configuration information. In some aspects, the second network entity 610 may receive the configuration information via one or more of system information signaling (e.g., a master information block (MIB) and/or a system information block (SIB), among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the second network entity 610. For example, in some aspects, the configuration information may at least partially be defined by a wireless communication standard, such as the 3GPP. In such examples, the first network entity 605 may not explicitly indicate such configuration information to the second network entity 610. For example, the second network entity 610 may optionally obtain at least a portion of the configuration information from a configuration stored by the second network entity 610 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate slot offset information for a type of HARQ ACK codebook. For example, the configuration information may indicate slot offset information for a semi-static HARQ ACK codebook (e.g., a Type 1 HARQ ACK codebook). The configuration information may indicate multiple sets of slot offset information for the type of HARQ ACK codebook. For example, the configuration information may indicate a first set of slot offset information and a second set of slot offset information. A “set of slot offset information” may indicate one or more slot offsets. A “set of slot offset information” may be used interchangeably with “K1 set.”

In some aspects, the multiple sets of slot offset information may be configured for respective feedback types. “Feedback type” refers to a classification that encompasses different levels of urgency or specific processes for transmitting feedback in a communication system. This classification can be used to prioritize or manage the transmission of feedback data, ensuring that more urgent feedback is transmitted promptly and according to predefined protocols specific to each type. For example, a feedback type might indicate high-priority feedback that requires immediate transmission with low latency, or a feedback type might refer to lower-priority feedback that can be transmitted with greater flexibility in timing. This classification allows for improved management of network resources and ensures the efficient handling of various communication requirements. As an example, a first feedback type may include indicating feedback in an indicated slot (e.g., indicated by DCI). A second feedback type may be associated with urgent or low latency feedback. For example, the second feedback type may be associated with transmitting feedback in a next available transmission occasion (e.g., a next available uplink time interval).

The configuration information may indicate a first set of slot offset information for the first feedback type and a second set of slot offset information for the second feedback type. In such examples, the first set of slot offset information may indicate a first quantity of slot offsets, and the second set of slot information may indicate a second quantity of slot offsets. The first quantity of slot offsets may be greater than the second quantity of slot offsets. This enables a size of a Type 1 HARQ ACK codebook transmitted for the second feedback type (e.g., that is scheduled or triggered to be transmitted in a next available transmission occasion) to be reduced while still indicating feedback for one or more communications (e.g., because the second set of slot offset information indicates or configures fewer slot offsets, thereby resulting in the size of the Type 1 HARQ ACK codebook being reduced).

By the first network entity 605 configuring multiple sets of slot offset information for the semi-static HARQ ACK codebook type, the first network entity 605 may dynamically cause the second network entity 610 to use given slot offset information for a given time interval (e.g., for a given uplink time interval or a given PUCCH time interval). For semi-static HARQ ACK codebook transmissions that are caused (e.g., by the first network entity 605) to be transmitted in an urgent manner (e.g., in a next available transmission occasion), this may result in a reduced size of the semi-static HARQ ACK codebook transmissions and/or may reduce the quantity of unnecessary NACK indications that are included in the semi-static HARQ ACK codebook transmissions. As a result, this improves the resource utilization efficiency for semi-static HARQ ACK codebook transmissions while also reducing signaling overhead that would have otherwise been associated with using dynamic HARQ ACK codebook transmissions for the feedback that is to be transmitted in an urgent manner (e.g., in a next available transmission occasion).

In some aspects, the configuration information may indicate a configuration for a type of HARQ ACK codebook. For example, the configuration information may indicate a configuration for a semi-static HARQ ACK codebook and/or a HARQ ACK codebook having a static or fixed size (e.g., the Type 1 HARQ ACK codebook). For example, the configuration information may include control channel configuration information. The control channel configuration information may be associated with an uplink control channel.

For example, the configuration information may include a PUCCH configuration (e.g., indicated by a PUCCH-Config IE). The multiple sets of slot offset information may be indicated via the PUCCH configuration. For example, the configuration information may include one or more fields (e.g., one or more parameters or IEs) configured for indicating slot offset information, such as a dl-DataToUL-ACK parameter. The one or more fields (e.g., the dl-DataToUL-ACK parameter) may indicate the multiple sets of slot offset information. In some aspects, the configuration may include multiple fields (e.g., multiple dl-DataToUL-ACK parameters) for respective sets of slot offset information from the multiple sets of slot offset information. For example, a first field (or first sub-field of a field) may indicate first slot offset information and a second field (or second sub-field of the field) may indicate second slot offset information.

In some aspects, the multiple sets of slot offset information may be defined or indicated relative to, or with respect to, a frame structure of an uplink carrier. For example, the slot offset information (e.g., indicated by the multiple sets of slot offset information) may indicate one or more time intervals (e.g., one or more feedback windows) for which the feedback information is to indicate feedback. The one or more time intervals may be relative to the frame structure of the uplink carrier. For example, slot offset information may indicate one or more slot offsets. The second network entity 610 may be configured to count a quantity of slots (e.g., indicated by the one or more slot offsets) with respect to slots defined or indicated by the frame structure of the uplink carrier (e.g., by a numerology, such as an SCS, of the uplink carrier). For example, the multiple sets of slot offset information may be defined with respect to a PUCCH component carrier. Each set of slot offset information may be indicative of a feedback window within which one or more downlink slots (e.g., PDSCH slot) are mapped to a given uplink slot associated with that set of slot offset information.

In other aspects, the multiple sets of slot offset information may be defined or indicated relative to, or with respect to, a frame structure of a downlink carrier (e.g., a downlink component carrier). For example, slot offset information may indicate one or more time intervals (e.g., one or more uplink slots) for which feedback information is to indicate feedback, where the slot offset information indicates the one or more time intervals relative to the frame structure of the downlink carrier. In other words, the multiple sets of slot offset information may be defined, or indicated, with respect to a PDSCH component carrier. In such examples, a set of slot offset information may indicate one or more uplink time intervals during which feedback for a given downlink time interval can be transmitted.

For example, a set of slot offset information may indicate one or more possible uplink time intervals for respective downlink time intervals indicated by the frame structure of the downlink carrier. The one or more possible uplink time intervals may be configured time intervals for the first network entity to transmit feedback for downlink communicates received during the respective downlink time intervals. For example, the first network entity 605 may transmit, and the second network entity 610 may receive, slot offset information for one or more downlink time intervals. The slot offset information indicates one or more uplink time intervals configured for feedback reporting for respective downlink time intervals of the one or more downlink time intervals. In such examples, the slot offset information may indicate that a given downlink slot (e.g., a given PDSCH slot) is mapped to one or more uplink time intervals (e.g., one or more PUCCH slots) during which feedback for the given downlink slot can be transmitted by the second network entity 610. In such examples, the second network entity 610 may determine downlink slots that are mapped to a given uplink slot based on the multiple sets of slot offset information for respective downlink slots.

By configuring uplink time intervals for respective downlink time intervals, the first network node 605 may improve the flexibility for configuring feedback by mapping downlink slots to specific uplink slots for feedback transmission, thereby enabling the first network node 605 to reduce the likelihood of network congestion and optimizing bandwidth usage. This approach also adds flexibility, allowing the network to dynamically adjust feedback reporting intervals based on current conditions, thus responding adaptively to varying communication demands. As a result, the QoS may be enhanced, such as for applications requiring low latency and high reliability.

In some aspects, the multiple sets of slot offset information may be indicated via a pattern. For example, the first network entity 605 may transmit, and the second network entity 610 may receive, a pattern indicative of one or more sets of slot offset information. In other words, the multiple set of slot offsets may be configured on a periodic basis. For example, a slot structure (e.g., a pattern of downlink slots, uplink slots, and/or special (or flexible) slots) may repeat over time. The slot structure may be a TDD pattern. In some examples, a periodic pattern may be configured that is indicative of sets of slot offset information for respective uplink time intervals included in the repeating slot structure (e.g., TDD pattern). For example, for a given period and for different slots of PUCCH component carrier (e.g., with respect to the SCS of PUCCH component carrier), different sets of slot offset information may be configured for respective uplink time intervals (e.g., uplink slots or PUCCH slots) as part of the pattern. The pattern may be relative to a frame structure of an uplink carrier (e.g., of an SCS of the uplink carrier or uplink component carrier). For example, the pattern may indicate one or more slot offsets for respective time intervals configured for uplink transmissions. In such examples, the pattern may indicate slot offset information for uplink time intervals (e.g., uplink slots, PUCCH slots, and/or special (or flexible) slots). In some aspects, the configuration information may indicate one or more patterns for respective downlink component carriers. For example, the first network entity 605 may configure separate patterns for each downlink component carrier via which downlink data can be scheduled for the second network entity 610.

As another example, a periodic pattern may be configured that is indicative of sets of slot offset information for respective downlink time intervals included in the repeating slot structure (e.g., TDD pattern). For example, the pattern may indicate one or more slot offsets for respective time intervals (e.g., downlink slots, PDSCH slots, and/or special (or flexible) slots) configured for downlink transmissions. For example, for one or more downlink time intervals indicated by the TDD pattern, the configuration information (e.g., via the pattern) may indicate respective slot offset information. For example, for different slots of PDSCH component carrier (e.g., with respect to an SCS of the PDSCH component carrier), the pattern may indicate sets of slot offset information for respective downlink time intervals. The pattern may be relative to a frame structure of a downlink carrier (e.g., relative to the SCS of the downlink carrier). In some aspects, the configuration information may indicate one or more patterns (e.g., for the downlink time intervals) for respective downlink component carriers. For example, the first network entity 605 may configure separate patterns for each downlink component carrier via which downlink data can be scheduled for the second network entity 610.

The configuration information may indicate a periodicity and/or offset (e.g., an offset indicating a starting point in time of the pattern) for the pattern. In some examples, the periodicity of the pattern may be based on, or otherwise associated with, a periodicity of the TDD pattern. For example, the periodicity of the pattern may have the same periodicity as the TDD pattern. As another example, the periodicity of the pattern may have an integer multiple of the periodicity of the TDD pattern.

As shown by reference number 625, the first network entity 605 may transmit, and the second network entity 610 may receive, an indication of slot offset information to be associated with a time interval. For example, the first network entity 605 may transmit, and the second network entity 610 may receive, a communication indicating that a feedback communication is to be transmitted during the time interval. The communication may include control information (e.g., DCI) indicating that the feedback communication is to be transmitted during the time interval. The feedback communication may include a semi-static HARQ ACK codebook, such as a Type 1 HARQ ACK codebook. The communication may indicate that the feedback communication is to be based on first slot offset information from the multiple sets of slot offset information configured for the semi-static HARQ ACK codebook.

For example, the communication may indicate a slot offset (e.g., from a set of slot offset information) via a field in the communication. The field may be a slot offset field. The slot offset field may be referred to as a k1 field. For example, the field may be a PDSCH-to-HARQ-feedback timing indicator field in DCI. For example, the communication may include a slot offset field that indicates the first slot offset information.

In some aspects, the slot offset field may be configured to indicate slot offsets indicated by the multiple sets of slot offset information (e.g., the first slot offset information and second slot offset information). For example, a union of all feedback windows (configured in the pattern as indicated by the multiple sets of slot offset information) may be considered in the DCI signaling. The slot offset field may have a size that enable the first network entity 605 to indicate any slot offset from the multiple sets of slot offset information. In such examples, the slot offset field may be configured to indicate a slot offset (e.g., a k₁ value) from a union of multiple sets of slot offset information (e.g., a union of multiple feedback windows). In such examples, the second network entity 610 may not expect to receive a slot offset, for an uplink time interval, that is not included in the multiple sets of slot offset information for that uplink time interval. For example, the second network entity 610 may not be expected to receive DCI scheduling a PDSCH transmission in slot n indicating a slot offset=k if the feedback window configured for the PUCCH slot n+k (as part of the pattern) does not include k in the feedback window. In other words, if an uplink time interval is configured with slot offset information, the second network entity 610 may expect to receive slot offsets for the uplink time interval as indicated by the slot offset information (e.g., even if the slot offset field is capable of indicating slot offsets from multiple sets of slot offset information). For example, if slot offset information for a first uplink time interval includes slot offsets {8, 7, 6, 5, 4, 3, 2} and slot offset information for a second uplink time interval includes a slot offset {2}, then the second network entity 610 is not expected to receive DCI scheduling feedback to be transmitted in the second uplink time interval with any values of the slot offset other than {2} (e.g., even though the slot offset field is configured to indicate slot offsets {8, 7, 6, 5, 4, 3, 2}).

In some aspects, a size of the slot offset field may be based on a quantity of uplink time intervals with which respective downlink time intervals are associated, as indicated by the multiple sets of slot offset information (e.g., the first slot offset information and the second slot offset information). For example, the multiple sets of slot offset information may be indicative of how many uplink time intervals each downlink time interval can be mapped to for feedback reporting. The size of the slot offset field may be configured to enable a maximum quantity, from the of uplink time intervals with which downlink time intervals are mapped to as indicated by the multiple sets of slot offset information. For example, if the multiple sets of slot offset information indicate that each downlink time interval can only be mapped to a single respective uplink time interval, then the slot offset field may not be needed or included in the DCI (e.g., because the downlink slot in which DCI is received will be indicative of the uplink slot in which feedback is to be transmitted for the scheduled PDSCH transmission). In another example, one or more downlink slots may be mapped to two or more uplink slots as indicated by the multiple sets of slot offset information. In such examples, the size of the slot offset field may be 1 bit (e.g., log₂2). For example, a bit-width of the slot offset field may be log₂N, where N is the maximum quantity of uplink slots that any given downlink slot can be mapped to as indicated by the multiple sets of slot offset information.

As another example, a size of the slot offset field is based on one or more sizes of feedback windows indicated by at least one set of slot information (e.g., the first slot offset information and/or the second slot offset information). For example, the size of the slot offset field may be based on the largest set of slot offset information. For example, a bit-width of the slot offset field may be log₂S, where S is the largest quantity of slot offsets indicated by a given set of slot offset information from the multiple sets of slot offset information. As another example, the size of the slot offset field may be based on the maximum size across the multiple feedback windows. For example, a bit-width of the slot offset field may be log₂F, where F is the largest feedback window indicated by the multiple sets of slot offset information. In some examples, if the slot offset information is configured with respect to the frame structure of the downlink carrier, the size of slot offset field may be based on the maximum set size amongst all configured set of slot offset information. In such examples, an interpretation of the slot offset field may be based on (e.g., may depend on) which downlink slot (e.g., which PDSCH slot) the communication (e.g., the DCI) is received by the second network entity 610.

As shown by reference number 630, the second network entity 610 may generate feedback information based on the slot offset information indicated by the first network entity 605 (e.g., in the communication as described in connection with reference number 625). For example, the second network entity 610 may determine an uplink time interval during which feedback (e.g., a Type 1 HARQ ACK codebook) is to be transmitted for a downlink communication (e.g., a PDSCH communication) scheduled by the communication (e.g., based on the slot offset indicated by the slot offset field in the communication). The second network entity 610 may determine a size of the feedback communication (e.g., a size of the Type 1 HARQ ACK codebook) based on possible downlink reception candidates in a feedback window indicated by the slot offset information configured for the uplink time interval (e.g., by the pattern).

In some examples, such as when the slot offset information is defined with respect to the frame structure of the slot offset information, the second network entity 610 may determine which downlink time intervals can be mapped to the indicated uplink time interval as indicated by slot offset information for respective downlink time intervals. The downlink time intervals that can be mapped to the indicated uplink time interval may be indicative of the possible downlink reception candidates.

The second network entity 610 may generate the feedback communication to have a size such that the feedback communication can indicate feedback (e.g., an ACK indication or a NACK indication) for each possible downlink reception candidate, in a similar manner as described in connection with FIG. 4. By configuring multiple sets of slot offset information and/or the pattern described herein, semi-static HARQ ACK codebook transmissions in some uplink time intervals may have a different size than other time intervals. This provides the flexibility to define smaller sets of slot offset information for some time intervals, enabling urgent feedback to be transmitted in a semi-static manner with improved resource utilization efficiency (e.g., because the size of the Type 1 HARQ ACK codebook for the urgent feedback can be smaller due to the separate slot offset information configured for the uplink time interval in which the urgent feedback is transmitted).

As shown by reference number 635, the second network entity 610 may transmit, and the first network entity 605 may receive, the feedback information (e.g., a feedback communication) during the time interval (e.g., the uplink time interval indicated by the slot offset in the communication transmitted as described in connection with reference number 625). The feedback information may be included in a Type 1 HARQ ACK codebook, as described in more detail elsewhere herein. Additionally, a size of the feedback information may be based on the slot offset information, from multiple sets of slot offset information, configured for the time interval (e.g., in which the feedback information is transmitted).

As indicated above, FIG. 6 is provided as an example. Other examples may differ from what is described with regard to FIG. 6.

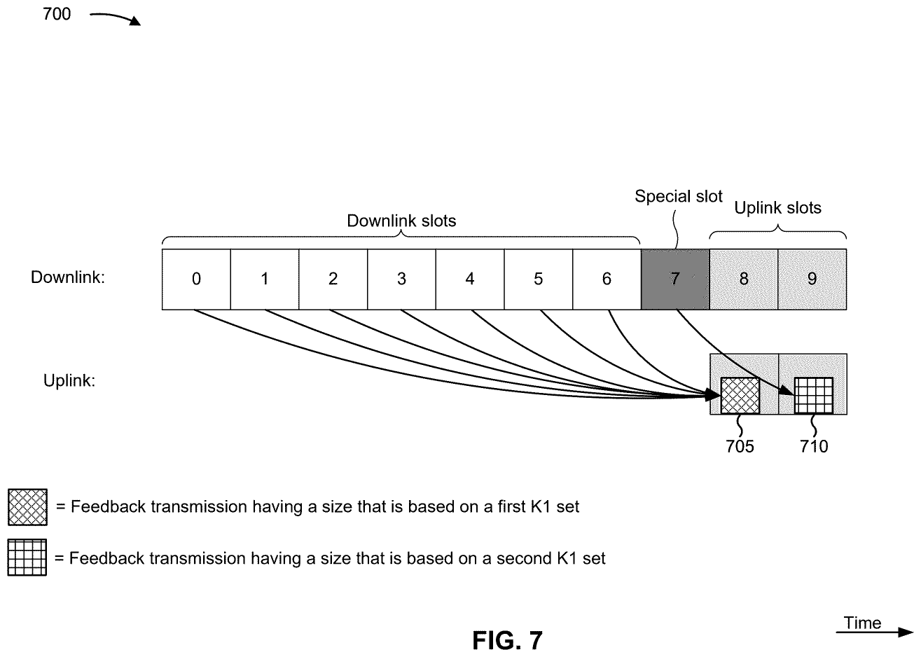

FIG. 7 is a diagram of an example 700 associated with slot offsets for feedback transmission with respect to an uplink carrier, in accordance with the present disclosure. Example 700 shows a TDD pattern that includes one or more downlink slots, one or more special (or flexible) slots and one or more uplink slots.

As described elsewhere herein, multiple sets of slot offset information may be configured for semi-state HARQ ACK codebooks (e.g., Type 1 HARQ ACK codebooks). For example, a first set of slot offset information may include slot offsets of {8, 7, 6, 5, 4, 3, 2} and a second set of slot offset information may include a slot offset of {2}. The first slot offset information may be the first K1 set described in FIG. 7, and the second slot offset information may be the second K1 set described in FIG. 7. In some aspects, the configuration information may indicate a pattern such that the uplink slot 8 shown in FIG. 7 is associated with the first slot offset information and the uplink slot 9 is associated with the second slot offset information.

As shown in FIG. 7, a feedback window for a Type 1 HARQ ACK codebook to be transmitting during the uplink slot 8 may be based on the first set of slot offset information (e.g., the first K1 set) including slot offsets of {8, 7, 6, 5, 4, 3, 2}. For example, as shown in FIG. 7, the downlink slots 0 through 6 may be mapped to the uplink slot 8 for feedback transmission. As a result, a feedback transmission 705 (e.g., the Type 1 HARQ ACK codebook) transmitted during the uplink slot 8 may have a size configured to indicate feedback for each possible downlink reception candidate that occurs during the downlink slots 0 through 6. A feedback window for a Type 1 HARQ ACK codebook to be transmitting during the uplink slot 9 may be based on the second set of slot offset information (e.g., the second K1 set) including a slot offset of {2}. For example, as shown in FIG. 7, the special slot 7 may be mapped to the uplink slot 9 for feedback transmission. As a result, a feedback transmission 710 (e.g., the Type 1 HARQ ACK codebook) transmitted during the uplink slot 9 may have a size configured to indicate feedback for each possible downlink reception candidate that occurs during the special slot 7. This may enable the feedback transmission 710 (e.g., the Type 1 HARQ ACK codebook) transmitted during the uplink slot 9 to have a relatively smaller size than the feedback transmission 705 (e.g., the Type 1 HARQ ACK codebook) transmitted during the uplink slot 8, thereby improving the resource utilization efficiency.

As indicated above, FIG. 7 is provided as an example. Other examples may differ from what is described with regard to FIG. 7.

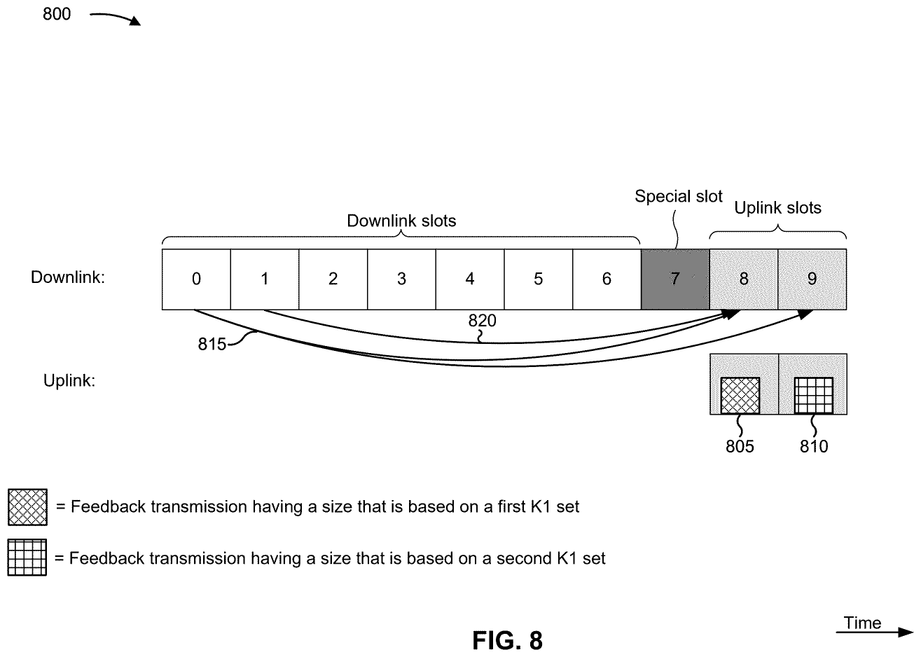

FIG. 8 is a diagram of an example 800 associated with slot offsets for feedback transmission with respect to a downlink carrier, in accordance with the present disclosure. Example 800 shows a TDD pattern that includes one or more downlink slots, one or more special (or flexible) slots and one or more uplink slots.

As described elsewhere herein, multiple sets of slot offset information may be configured for semi-state HARQ ACK codebooks (e.g., Type 1 HARQ ACK codebooks). For example, as shown in FIG. 8, a given downlink slot may be configured with a set of slot offset information. For example, as shown by reference number 815, the configuration information (e.g., a pattern) may indicate that slot offset information for the downlink slot 0 maps the downlink slot 0 to the uplink slot 8 and the uplink slot 9 for Type 1 HARQ ACK codebook transmissions. For example, the slot offset information for the downlink slot 0 may include slot offsets of {8, 9}. As shown by reference number 820, the configuration information (e.g., a pattern) may indicate that slot offset information for the downlink slot 1 maps the downlink slot 1 to the uplink slot 8 for Type 1 HARQ ACK codebook transmissions. For example, the slot offset information for the downlink slot 0 may include a slot offset of {7}. Other downlink slots may be mapped to one or more uplink time intervals in a similar manner.

As shown in FIG. 8, a feedback transmission 805 (e.g., a Type 1 HARQ ACK codebook transmission) may be transmitted on an uplink carrier during the uplink slot 8. The feedback transmission 805 may have a size that is based on all downlink time intervals that are mapped to the uplink slot 8 via the multiple sets of slot offset information (e.g., the downlink slot 0 and the downlink slot 1 may be candidate downlink reception opportunities for the Type 1 HARQ ACK codebook included in the feedback transmission 805). Similarly, a feedback transmission 810 (e.g., a Type 1 HARQ ACK codebook transmission) may be transmitted on an uplink carrier during the uplink slot 9. The feedback transmission 810 may have a size that is based on all downlink time intervals that are mapped to the uplink slot 9 via the multiple sets of slot offset information (e.g., the downlink slot 0 may be the candidate downlink reception opportunity for the Type 1 HARQ ACK codebook included in the feedback transmission 810). By configuring or defining the slot offset information with respect to the frame structure of the downlink carrier, as shown in FIG. 8, a network entity (e.g., the first network entity 605) may have increased flexibility for mapping downlink time intervals to different uplink time intervals for the purpose of Type 1 HARQ ACK codebook transmissions.

As indicated above, FIG. 8 is provided as an example. Other examples may differ from what is described with regard to FIG. 8.

FIG. 9 is a diagram illustrating an example process 900 performed, for example, at a first network entity or an apparatus of a first network entity, in accordance with the present disclosure. Example process 900 is an example where the apparatus or the first network entity (e.g., network entity 102, network entity 104, network entity 104, UE 220, and/or the second network node 610) performs operations associated with slot offsets for feedback transmission.

As shown in FIG. 9, in some aspects, process 900 may include receiving, from a second network entity, first slot offset information and second slot offset information (block 910). For example, the first network entity (e.g., using reception component 1302 and/or communication manager 1306, depicted in FIG. 13) may receive, from a second network entity, first slot offset information and second slot offset information, as described above.

As further shown in FIG. 9, in some aspects, process 900 may include receiving, from the second network entity, a communication indicating that a feedback communication is to be transmitted during a time interval, wherein the communication indicates that the feedback communication is to be based on the first slot offset information (block 920). For example, the first network entity (e.g., using reception component 1302 and/or communication manager 1306, depicted in FIG. 13) may receive, from the second network entity, a communication indicating that a feedback communication is to be transmitted during a time interval, wherein the communication indicates that the feedback communication is to be based on the first slot offset information, as described above.

As further shown in FIG. 9, in some aspects, process 900 may include transmitting, to the second network entity and during the time interval, the feedback communication, wherein the feedback communication includes feedback information that is based on the first slot offset information (block 930). For example, the first network entity (e.g., using transmission component 1304 and/or communication manager 1306, depicted in FIG. 13) may transmit, to the second network entity and during the time interval, the feedback communication, wherein the feedback communication includes feedback information that is based on the first slot offset information, as described above.

Process 900 may include additional aspects, such as any single aspect or any combination of aspects described below and/or in connection with one or more other processes described elsewhere herein.

In a first aspect, the first slot offset information and the second slot offset information are configured for a feedback codebook type having a fixed size, and the feedback communication includes a feedback codebook having the feedback codebook type.

In a second aspect, alone or in combination with the first aspect, the feedback codebook type is a Type 1 HARQ acknowledgment codebook.

In a third aspect, alone or in combination with one or more of the first and second aspects, a size of the feedback communication is based on the first slot offset information.

In a fourth aspect, alone or in combination with one or more of the first through third aspects, the first network entity is configured to communicate via an uplink carrier, and the first slot offset information is configured with respect to a frame structure of the uplink carrier.

In a fifth aspect, alone or in combination with one or more of the first through fourth aspects, the first slot offset information indicates one or more time intervals for which the feedback information is to indicate feedback, and the first slot offset information indicates the one or more time intervals relative to the frame structure of the uplink carrier.

In a sixth aspect, alone or in combination with one or more of the first through fifth aspects, the first slot offset information indicates a feedback window that includes one or more downlink time intervals for which the feedback information is to indicate feedback, and the feedback window is relative to an uplink time interval indicated by the frame structure of the uplink carrier.

In a seventh aspect, alone or in combination with one or more of the first through sixth aspects, the first network entity is configured to communicate via a downlink carrier, and the first slot offset information is configured with respect to a frame structure of the downlink carrier.

In an eighth aspect, alone or in combination with one or more of the first through seventh aspects, the first slot offset information indicates one or more time intervals for which the feedback information is to indicate feedback, and the first slot offset information indicates the one or more time intervals relative to the frame structure of the downlink carrier.

In a ninth aspect, alone or in combination with one or more of the first through eighth aspects, the first slot offset information indicates one or more possible uplink time intervals for respective downlink time intervals indicated by the frame structure of the downlink carrier, wherein the one or more possible uplink time intervals are configured time intervals for the first network entity to transmit feedback for downlink communicates received during the respective downlink time intervals.

In a tenth aspect, alone or in combination with one or more of the first through ninth aspects, receiving the first slot offset information and the second slot offset information includes receiving a pattern indicative of the first slot offset information.

In an eleventh aspect, alone or in combination with one or more of the first through tenth aspects, the pattern indicates one or more slot offsets for respective time intervals configured for uplink transmissions.

In a twelfth aspect, alone or in combination with one or more of the first through eleventh aspects, the pattern indicates one or more slot offsets for respective time intervals configured for downlink transmissions.

In a thirteenth aspect, alone or in combination with one or more of the first through twelfth aspects, the pattern includes one or more patterns for respective downlink carriers configured for the first network entity.

In a fourteenth aspect, alone or in combination with one or more of the first through thirteenth aspects, the pattern is relative to a frame structure of an uplink carrier.

In a fifteenth aspect, alone or in combination with one or more of the first through fourteenth aspects, the pattern is relative to a frame structure of a downlink carrier.

In a sixteenth aspect, alone or in combination with one or more of the first through fifteenth aspects, the communication includes a slot offset field that indicates the first slot offset information.

In a seventeenth aspect, alone or in combination with one or more of the first through sixteenth aspects, the slot offset field is configured to indicate slot offsets indicated by the first slot offset information and the second slot offset information.

In an eighteenth aspect, alone or in combination with one or more of the first through seventeenth aspects, process 900 includes indicating one or more slot offsets only indicated by the first slot offset information based on the feedback communication being associated with the first slot offset information.

In a nineteenth aspect, alone or in combination with one or more of the first through eighteenth aspects, a size of the slot offset field is based on a quantity of uplink time intervals with which respective downlink time intervals are associated, as indicated by the first slot offset information and the second slot offset information.

In a twentieth aspect, alone or in combination with one or more of the first through nineteenth aspects, a size of the slot offset field is based on one or more sizes of feedback windows indicated by at least one of the first slot offset information or the second slot offset information.

In a twenty-first aspect, alone or in combination with one or more of the first through twentieth aspects, a size of the slot offset field is based on a quantity of slot offsets indicated by the first slot offset information and the second slot offset information.

In a twenty-second aspect, alone or in combination with one or more of the first through twenty-first aspects, the first slot offset information is associated with a first feedback reporting type, and the second slot offset information is associated with a second feedback reporting type.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a first network entity or an apparatus of a first network entity, in accordance with the present disclosure. Example process 1000 is an example where the apparatus or the first network entity (e.g., network entity 102, network entity 104, network entity 104, network node 210, and/or the first network node 605) performs operations associated with slot offsets for feedback transmission.

As shown in FIG. 10, in some aspects, process 1000 may include transmitting, to a second network entity, first slot offset information and second slot offset information (block 1010). For example, the first network entity (e.g., using transmission component 1404 and/or communication manager 1406, depicted in FIG. 14) may transmit, to a second network entity, first slot offset information and second slot offset information, as described above.

As further shown in FIG. 10, in some aspects, process 1000 may include transmitting, to the second network entity, a communication indicating that a feedback communication is to be transmitted during a time interval, wherein the communication indicates that the feedback communication is to be based on the first slot offset information (block 1020). For example, the first network entity (e.g., using transmission component 1404 and/or communication manager 1406, depicted in FIG. 14) may transmit, to the second network entity, a communication indicating that a feedback communication is to be transmitted during a time interval, wherein the communication indicates that the feedback communication is to be based on the first slot offset information, as described above.

As further shown in FIG. 10, in some aspects, process 1000 may include receiving, from the second network entity and during the time interval, the feedback communication, wherein the feedback communication includes feedback information that is based on the first slot offset information (block 1030). For example, the first network entity (e.g., using reception component 1402 and/or communication manager 1406, depicted in FIG. 14) may receive, from the second network entity and during the time interval, the feedback communication, wherein the feedback communication includes feedback information that is based on the first slot offset information, as described above.

Process 1000 may include additional aspects, such as any single aspect or any combination of aspects described below and/or in connection with one or more other processes described elsewhere herein.

In a first aspect, the first slot offset information and the second slot offset information are configured for a feedback codebook type having a fixed size, and the feedback communication includes a feedback codebook having the feedback codebook type.

In a second aspect, alone or in combination with the first aspect, the feedback codebook type is a Type 1 HARQ acknowledgment codebook.

In a third aspect, alone or in combination with one or more of the first and second aspects, a size of the feedback communication is based on the first slot offset information.

In a fourth aspect, alone or in combination with one or more of the first through third aspects, the second network entity is configured to communicate via an uplink carrier, and the first slot offset information is configured with respect to a frame structure of the uplink carrier.

In a fifth aspect, alone or in combination with one or more of the first through fourth aspects, the first slot offset information indicates one or more time intervals for which the feedback information is to indicate feedback, and the first slot offset information indicates the one or more time intervals relative to the frame structure of the uplink carrier.

In a sixth aspect, alone or in combination with one or more of the first through fifth aspects, the first slot offset information indicates a feedback window that includes one or more downlink time intervals for which the feedback information is to indicate feedback, and the feedback window is relative to an uplink time interval indicated by the frame structure of the uplink carrier.

In a seventh aspect, alone or in combination with one or more of the first through sixth aspects, the second network entity is configured to communicate via a downlink carrier, and the first slot offset information is configured with respect to a frame structure of the downlink carrier.

In an eighth aspect, alone or in combination with one or more of the first through seventh aspects, the first slot offset information indicates one or more time intervals for which the feedback information is to indicate feedback, and the first slot offset information indicates the one or more time intervals relative to the frame structure of the downlink carrier.

In a ninth aspect, alone or in combination with one or more of the first through eighth aspects, the first slot offset information indicates one or more possible uplink time intervals for respective downlink time intervals indicated by the frame structure of the downlink carrier, wherein the one or more possible uplink time intervals are configured time intervals for the first network entity to transmit feedback for downlink communicates received during the respective downlink time intervals.

In a tenth aspect, alone or in combination with one or more of the first through ninth aspects, transmitting the first slot offset information and the second slot offset information includes transmitting a pattern indicative of the first slot offset information.

In an eleventh aspect, alone or in combination with one or more of the first through tenth aspects, the pattern indicates one or more slot offsets for respective time intervals configured for uplink transmissions.

In a twelfth aspect, alone or in combination with one or more of the first through eleventh aspects, the pattern indicates one or more slot offsets for respective time intervals configured for downlink transmissions.

In a thirteenth aspect, alone or in combination with one or more of the first through twelfth aspects, the pattern includes one or more patterns for respective downlink carriers configured for the first network entity.

In a fourteenth aspect, alone or in combination with one or more of the first through thirteenth aspects, the pattern is relative to a frame structure of an uplink carrier.

In a fifteenth aspect, alone or in combination with one or more of the first through fourteenth aspects, the pattern is relative to a frame structure of a downlink carrier.

In a sixteenth aspect, alone or in combination with one or more of the first through fifteenth aspects, the communication includes a slot offset field that indicates the first slot offset information.

In a seventeenth aspect, alone or in combination with one or more of the first through sixteenth aspects, process 1000 includes indicating slot offsets indicated by the first slot offset information and the second slot offset information.

In an eighteenth aspect, alone or in combination with one or more of the first through seventeenth aspects, process 1000 includes indicating one or more slot offsets only indicated by the first slot offset information based on the feedback communication being associated with the first slot offset information.

In a nineteenth aspect, alone or in combination with one or more of the first through eighteenth aspects, a size of the slot offset field is based on a quantity of uplink time intervals with which respective downlink time intervals are associated, as indicated by the first slot offset information and the second slot offset information.

In a twentieth aspect, alone or in combination with one or more of the first through nineteenth aspects, a size of the slot offset field is based on one or more sizes of feedback windows indicated by at least one of the first slot offset information or the second slot offset information.

In a twenty-first aspect, alone or in combination with one or more of the first through twentieth aspects, a size of the slot offset field is based on a quantity of slot offsets indicated by the first slot offset information and the second slot offset information.

In a twenty-second aspect, alone or in combination with one or more of the first through twenty-first aspects, the first slot offset information is associated with a first feedback reporting type, and the second slot offset information is associated with a second feedback reporting type.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a first network entity or an apparatus of a first network entity, in accordance with the present disclosure. Example process 1100 is an example where the apparatus or the first network entity (e.g., network entity 102, network entity 104, network entity 104, UE 220, and/or the second network node 610) performs operations associated with slot offsets for feedback transmission.

As shown in FIG. 11, in some aspects, process 1100 may include receiving slot offset information for one or more downlink time intervals, wherein the slot offset information indicates one or more uplink time intervals configured for feedback reporting for respective downlink time intervals of the one or more downlink time intervals (block 1110). For example, the first network entity (e.g., using reception component 1302 and/or communication manager 1306, depicted in FIG. 13) may receive slot offset information for one or more downlink time intervals, wherein the slot offset information indicates one or more uplink time intervals configured for feedback reporting for respective downlink time intervals of the one or more downlink time intervals, as described above.

As further shown in FIG. 11, in some aspects, process 1100 may include transmitting, during an uplink time interval of the one or more uplink time intervals, feedback information for at least one downlink time interval, of the one or more downlink time intervals, indicated by the slot offset information as being associated with the uplink time interval (block 1120). For example, the first network entity (e.g., using transmission component 1304 and/or communication manager 1306, depicted in FIG. 13) may transmit, during an uplink time interval of the one or more uplink time intervals, feedback information for at least one downlink time interval, of the one or more downlink time intervals, indicated by the slot offset information as being associated with the uplink time interval, as described above.

Process 1100 may include additional aspects, such as any single aspect or any combination of aspects described below and/or in connection with one or more other processes described elsewhere herein.

In a first aspect, the slot offset information indicates one or more slot offsets for the respective downlink time intervals of the one or more downlink time intervals, wherein the one or more slot offsets indicate the one or more uplink time intervals.

In a second aspect, alone or in combination with the first aspect, the slot offset information is periodically updated.

In a third aspect, alone or in combination with one or more of the first and second aspects, the slot offset information indicates a pattern of slot offsets for the respective downlink time intervals of the one or more downlink time intervals.

In a fourth aspect, alone or in combination with one or more of the first through third aspects, the slot offset information is configured for respective downlink carriers configured for the first network entity.

In a fifth aspect, alone or in combination with one or more of the first through fourth aspects, the feedback information is HARQ information.

In a sixth aspect, alone or in combination with one or more of the first through fifth aspects, the feedback information is associated with a HARQ codebook type that has a fixed size.

In a seventh aspect, alone or in combination with one or more of the first through sixth aspects, the HARQ codebook type is a Type 1 HARQ acknowledgement codebook.

In an eighth aspect, alone or in combination with one or more of the first through seventh aspects, a size of the feedback information is based on a quantity of downlink time intervals associated with the uplink time interval, as indicated by the slot offset information.

In a ninth aspect, alone or in combination with one or more of the first through eighth aspects, process 1100 includes receiving a communication indicating one or more slot offsets indicated by the slot offset information, wherein the one or more slot offsets are indicated via a slot offset field, and wherein a size of the slot offset field is based on quantities of slot offsets indicated for the respective downlink time intervals of the one or more downlink time intervals.

In a tenth aspect, alone or in combination with one or more of the first through ninth aspects, process 1100 includes receiving second slot offset information for a second feedback reporting type.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a first network entity or an apparatus of a first network entity, in accordance with the present disclosure. Example process 1200 is an example where the apparatus or the first network entity (e.g., network entity 102, network entity 104, network entity 104, network node 210, and/or the first network node 605) performs operations associated with slot offsets for feedback transmission.

As shown in FIG. 12, in some aspects, process 1200 may include transmitting slot offset information for one or more downlink time intervals, wherein the slot offset information indicates one or more uplink time intervals configured for feedback reporting for respective downlink time intervals of the one or more downlink time intervals (block 1210). For example, the first network entity (e.g., using transmission component 1404 and/or communication manager 1406, depicted in FIG. 14) may transmit slot offset information for one or more downlink time intervals, wherein the slot offset information indicates one or more uplink time intervals configured for feedback reporting for respective downlink time intervals of the one or more downlink time intervals, as described above.

As further shown in FIG. 12, in some aspects, process 1200 may include receiving, during an uplink time interval of the one or more uplink time intervals, feedback information for at least one downlink time interval, of the one or more downlink time intervals, indicated by the slot offset information as being associated with the uplink time interval (block 1220). For example, the first network entity (e.g., using reception component 1402 and/or communication manager 1406, depicted in FIG. 14) may receive, during an uplink time interval of the one or more uplink time intervals, feedback information for at least one downlink time interval, of the one or more downlink time intervals, indicated by the slot offset information as being associated with the uplink time interval, as described above.

Process 1200 may include additional aspects, such as any single aspect or any combination of aspects described below and/or in connection with one or more other processes described elsewhere herein.

In a first aspect, the slot offset information indicates one or more slot offsets for the respective downlink time intervals of the one or more downlink time intervals, wherein the one or more slot offsets indicate the one or more uplink time intervals.

In a second aspect, alone or in combination with the first aspect, the slot offset information is periodically updated.

In a third aspect, alone or in combination with one or more of the first and second aspects, the slot offset information indicates a pattern of slot offsets for the respective downlink time intervals of the one or more downlink time intervals.

In a fourth aspect, alone or in combination with one or more of the first through third aspects, the slot offset information is configured for respective downlink carriers configured for the first network entity.

In a fifth aspect, alone or in combination with one or more of the first through fourth aspects, the feedback information is HARQ information.

In a sixth aspect, alone or in combination with one or more of the first through fifth aspects, the feedback information is associated with a HARQ codebook type that has a fixed size.

In a seventh aspect, alone or in combination with one or more of the first through sixth aspects, the HARQ codebook type is a Type 1 HARQ acknowledgement codebook.

In an eighth aspect, alone or in combination with one or more of the first through seventh aspects, a size of the feedback information is based on a quantity of downlink time intervals associated with the uplink time interval, as indicated by the slot offset information.

In a ninth aspect, alone or in combination with one or more of the first through eighth aspects, process 1200 includes transmitting a communication indicating one or more slot offsets indicated by the slot offset information, wherein the one or more slot offsets are indicated via a slot offset field, and wherein a size of the slot offset field is based on quantities of slot offsets indicated for the respective downlink time intervals of the one or more downlink time intervals.

In a tenth aspect, alone or in combination with one or more of the first through ninth aspects, process 1200 includes transmitting second slot offset information for a second feedback reporting type.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a network entity, or a network entity may include the apparatus 1300. In some aspects, the network entity may be a UE. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 114, the communication manager 118, and/or the communication manager 250. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 110, the processing system 112, and/or the processing system 240).

In some aspects, the apparatus 1300 may be configured to perform one or more operations described herein in connection with FIGS. 6-8. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the network entity described in connection with FIGS. 1-3. Additionally, or alternatively, one or more components shown in FIG. 13 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network entity described above in connection with FIGS. 1-3, such as a radio, one or more RF chains, one or more transceivers, or one or more modems, each of which may in turn be coupled with one or more antennas of the network entity.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network entity described above in connection with FIGS. 1-3, such as a radio, one or more RF chains, one or more transceivers, or one or more modems, each of which may in turn be coupled with one or more antennas of the network entity described in connection with FIGS. 1-3. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive, from a second network entity, first slot offset information and second slot offset information. The reception component 1302 may receive, from the second network entity, a communication indicating that a feedback communication is to be transmitted during a time interval, wherein the communication indicates that the feedback communication is to be based on the first slot offset information. The transmission component 1304 may transmit, to the second network entity and during the time interval, the feedback communication, wherein the feedback communication includes feedback information that is based on the first slot offset information.

The communication manager 1306 may indicate one or more slot offsets only indicated by the first slot offset information based on the feedback communication being associated with the first slot offset information.

The reception component 1302 may receive slot offset information for one or more downlink time intervals, wherein the slot offset information indicates one or more uplink time intervals configured for feedback reporting for respective downlink time intervals of the one or more downlink time intervals. The transmission component 1304 may transmit, during an uplink time interval of the one or more uplink time intervals, feedback information for at least one downlink time interval, of the one or more downlink time intervals, indicated by the slot offset information as being associated with the uplink time interval.

The reception component 1302 may receive a communication indicating one or more slot offsets indicated by the slot offset information, wherein the one or more slot offsets are indicated via a slot offset field, and wherein a size of the slot offset field is based on quantities of slot offsets indicated for the respective downlink time intervals of the one or more downlink time intervals.

The reception component 1302 may receive second slot offset information for a second feedback reporting type.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network entity, or a network entity may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 114, the communication manager 118, and/or the communication manager 255. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 110, the processing system 112, and/or the processing system 245).

In some aspects, the apparatus 1400 may be configured to perform one or more operations described herein in connection with FIGS. 6-8. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the network entity described in connection with FIGS. 1-3. Additionally, or alternatively, one or more components shown in FIG. 14 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network entity described above in connection with FIGS. 1-3, such as a radio, one or more RF chains, one or more transceivers, or one or more modems, each of which may in turn be coupled with one or more antennas of the network entity.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network entity described above in connection with FIG. 1, such as a radio, one or more RF chains, one or more transceivers, or one or more modems, each of which may in turn be coupled with one or more antennas of the network entity described in connection with FIGS. 1-3. In some aspects, the transmission component 1404 may be co-located with the reception component 1402.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit, to a second network entity, first slot offset information and second slot offset information. The transmission component 1404 may transmit, to the second network entity, a communication indicating that a feedback communication is to be transmitted during a time interval, wherein the communication indicates that the feedback communication is to be based on the first slot offset information. The reception component 1402 may receive, from the second network entity and during the time interval, the feedback communication, wherein the feedback communication includes feedback information that is based on the first slot offset information.

The communication manager 1406 may indicate slot offsets indicated by the first slot offset information and the second slot offset information.

The communication manager 1406 may indicate one or more slot offsets only indicated by the first slot offset information based on the feedback communication being associated with the first slot offset information.

The transmission component 1404 may transmit slot offset information for one or more downlink time intervals, wherein the slot offset information indicates one or more uplink time intervals configured for feedback reporting for respective downlink time intervals of the one or more downlink time intervals. The reception component 1402 may receive, during an uplink time interval of the one or more uplink time intervals, feedback information for at least one downlink time interval, of the one or more downlink time intervals, indicated by the slot offset information as being associated with the uplink time interval.

The transmission component 1404 may transmit a communication indicating one or more slot offsets indicated by the slot offset information, wherein the one or more slot offsets are indicated via a slot offset field, and wherein a size of the slot offset field is based on quantities of slot offsets indicated for the respective downlink time intervals of the one or more downlink time intervals.

The transmission component 1404 may transmit second slot offset information for a second feedback reporting type.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a first network entity, comprising: receiving, from a second network entity, first slot offset information and second slot offset information; receiving, from the second network entity, a communication indicating that a feedback communication is to be transmitted during a time interval, wherein the communication indicates that the feedback communication is to be based on the first slot offset information; and transmitting, to the second network entity and during the time interval, the feedback communication, wherein the feedback communication includes feedback information that is based on the first slot offset information.
Aspect 2: The method of Aspect 1, wherein the first slot offset information and the second slot offset information are configured for a feedback codebook type having a fixed size, and wherein the feedback communication includes a feedback codebook having the feedback codebook type.
Aspect 3: The method of Aspect 2, wherein the feedback codebook type is a Type 1 hybrid automatic repeat request (HARQ) acknowledgment codebook.
Aspect 4: The method of any of Aspects 1-3, wherein a size of the feedback communication is based on the first slot offset information.
Aspect 5: The method of any of Aspects 1-4, wherein the first network entity is configured to communicate via an uplink carrier, and wherein the first slot offset information is configured with respect to a frame structure of the uplink carrier.
Aspect 6: The method of Aspect 5, wherein the first slot offset information indicates one or more time intervals for which the feedback information is to indicate feedback, and wherein the first slot offset information indicates the one or more time intervals relative to the frame structure of the uplink carrier.
Aspect 7: The method of any of Aspects 5-6, wherein the first slot offset information indicates a feedback window that includes one or more downlink time intervals for which the feedback information is to indicate feedback, and wherein the feedback window is relative to an uplink time interval indicated by the frame structure of the uplink carrier.
Aspect 8: The method of any of Aspects 1-7, wherein the first network entity is configured to communicate via a downlink carrier, and wherein the first slot offset information is configured with respect to a frame structure of the downlink carrier.
Aspect 9: The method of Aspect 8, wherein the first slot offset information indicates one or more time intervals for which the feedback information is to indicate feedback, and wherein the first slot offset information indicates the one or more time intervals relative to the frame structure of the downlink carrier.
Aspect 10: The method of any of Aspects 8-9, wherein the first slot offset information indicates one or more possible uplink time intervals for respective downlink time intervals indicated by the frame structure of the downlink carrier, wherein the one or more possible uplink time intervals are configured time intervals for the first network entity to transmit feedback for downlink communicates received during the respective downlink time intervals.
Aspect 11: The method of any of Aspects 1-10, wherein receiving the first slot offset information and the second slot offset information comprises: receiving a pattern indicative of the first slot offset information.
Aspect 12: The method of Aspect 11, wherein the pattern indicates one or more slot offsets for respective time intervals configured for uplink transmissions.
Aspect 13: The method of any of Aspects 11-12, wherein the pattern indicates one or more slot offsets for respective time intervals configured for downlink transmissions.
Aspect 14: The method of any of Aspects 11-13, wherein the pattern includes one or more patterns for respective downlink carriers configured for the first network entity.
Aspect 15: The method of any of Aspects 11-14, wherein the pattern is relative to a frame structure of an uplink carrier.
Aspect 16: The method of any of Aspects 11-14, wherein the pattern is relative to a frame structure of a downlink carrier.
Aspect 17: The method of any of Aspects 1-16, wherein the communication includes a slot offset field that indicates the first slot offset information.
Aspect 18: The method of Aspect 17, wherein the slot offset field is configured to indicate slot offsets indicated by the first slot offset information and the second slot offset information.
Aspect 19: The method of Aspect 18, further comprising indicating one or more slot offsets only indicated by the first slot offset information based on the feedback communication being associated with the first slot offset information.
Aspect 20: The method of any of Aspects 17-19, wherein a size of the slot offset field is based on a quantity of uplink time intervals with which respective downlink time intervals are associated, as indicated by the first slot offset information and the second slot offset information.
Aspect 21: The method of any of Aspects 17-20, wherein a size of the slot offset field is based on one or more sizes of feedback windows indicated by at least one of the first slot offset information or the second slot offset information.
Aspect 22: The method of any of Aspects 17-21, wherein a size of the slot offset field is based on a quantity of slot offsets indicated by the first slot offset information and the second slot offset information.
Aspect 23: The method of any of Aspects 1-22, wherein the first slot offset information is associated with a first feedback reporting type, and wherein the second slot offset information is associated with a second feedback reporting type.
Aspect 24: A method of wireless communication performed by a first network entity, comprising: transmitting, to a second network entity, first slot offset information and second slot offset information; transmitting, to the second network entity, a communication indicating that a feedback communication is to be transmitted during a time interval, wherein the communication indicates that the feedback communication is to be based on the first slot offset information; and receiving, from the second network entity and during the time interval, the feedback communication, wherein the feedback communication includes feedback information that is based on the first slot offset information.
Aspect 25: The method of Aspect 24, wherein the first slot offset information and the second slot offset information are configured for a feedback codebook type having a fixed size, and wherein the feedback communication includes a feedback codebook having the feedback codebook type.
Aspect 26: The method of Aspect 25, wherein the feedback codebook type is a Type 1 hybrid automatic repeat request (HARQ) acknowledgment codebook.
Aspect 27: The method of any of Aspects 24-26, wherein a size of the feedback communication is based on the first slot offset information.
Aspect 28: The method of any of Aspects 24-27, wherein the second network entity is configured to communicate via an uplink carrier, and wherein the first slot offset information is configured with respect to a frame structure of the uplink carrier.
Aspect 29: The method of Aspect 28, wherein the first slot offset information indicates one or more time intervals for which the feedback information is to indicate feedback, and wherein the first slot offset information indicates the one or more time intervals relative to the frame structure of the uplink carrier.
Aspect 30: The method of any of Aspects 28-29, wherein the first slot offset information indicates a feedback window that includes one or more downlink time intervals for which the feedback information is to indicate feedback, and wherein the feedback window is relative to an uplink time interval indicated by the frame structure of the uplink carrier.
Aspect 31: The method of any of Aspects 24-30, wherein the second network entity is configured to communicate via a downlink carrier, and wherein the first slot offset information is configured with respect to a frame structure of the downlink carrier.
Aspect 32: The method of Aspect 31, wherein the first slot offset information indicates one or more time intervals for which the feedback information is to indicate feedback, and wherein the first slot offset information indicates the one or more time intervals relative to the frame structure of the downlink carrier.
Aspect 33: The method of any of Aspects 31-32, wherein the first slot offset information indicates one or more possible uplink time intervals for respective downlink time intervals indicated by the frame structure of the downlink carrier, wherein the one or more possible uplink time intervals are configured time intervals for the first network entity to transmit feedback for downlink communicates received during the respective downlink time intervals.
Aspect 34: The method of any of Aspects 24-33, wherein transmitting the first slot offset information and the second slot offset information comprises: transmitting a pattern indicative of the first slot offset information.
Aspect 35: The method of Aspect 34, wherein the pattern indicates one or more slot offsets for respective time intervals configured for uplink transmissions.
Aspect 36: The method of any of Aspects 34-35, wherein the pattern indicates one or more slot offsets for respective time intervals configured for downlink transmissions.
Aspect 37: The method of any of Aspects 34-36, wherein the pattern includes one or more patterns for respective downlink carriers configured for the first network entity.
Aspect 38: The method of any of Aspects 34-37, wherein the pattern is relative to a frame structure of an uplink carrier.
Aspect 39: The method of any of Aspects 34-37, wherein the pattern is relative to a frame structure of a downlink carrier.
Aspect 40: The method of any of Aspects 24-39, wherein the communication includes a slot offset field that indicates the first slot offset information.
Aspect 41: The method of Aspect 40, further comprising indicating slot offsets indicated by the first slot offset information and the second slot offset information.
Aspect 42: The method of Aspect 41, further comprising indicating one or more slot offsets only indicated by the first slot offset information based on the feedback communication being associated with the first slot offset information.
Aspect 43: The method of any of Aspects 40-42, wherein a size of the slot offset field is based on a quantity of uplink time intervals with which respective downlink time intervals are associated, as indicated by the first slot offset information and the second slot offset information.
Aspect 44: The method of any of Aspects 40-43, wherein a size of the slot offset field is based on one or more sizes of feedback windows indicated by at least one of the first slot offset information or the second slot offset information.
Aspect 45: The method of any of Aspects 40-44, wherein a size of the slot offset field is based on a quantity of slot offsets indicated by the first slot offset information and the second slot offset information.
Aspect 46: The method of any of Aspects 24-45, wherein the first slot offset information is associated with a first feedback reporting type, and wherein the second slot offset information is associated with a second feedback reporting type.
Aspect 47: A method of wireless communication performed by a first network entity, comprising: receiving slot offset information for one or more downlink time intervals, wherein the slot offset information indicates one or more uplink time intervals configured for feedback reporting for respective downlink time intervals of the one or more downlink time intervals; and transmitting, during an uplink time interval of the one or more uplink time intervals, feedback information for at least one downlink time interval, of the one or more downlink time intervals, indicated by the slot offset information as being associated with the uplink time interval.
Aspect 48: The method of Aspect 47, wherein the slot offset information indicates one or more slot offsets for the respective downlink time intervals of the one or more downlink time intervals, wherein the one or more slot offsets indicate the one or more uplink time intervals.
Aspect 49: The method of any of Aspects 47-48, wherein the slot offset information is periodically updated.
Aspect 50: The method of any of Aspects 47-49, wherein the slot offset information indicates a pattern of slot offsets for the respective downlink time intervals of the one or more downlink time intervals.
Aspect 51: The method of any of Aspects 47-50, wherein the slot offset information is configured for respective downlink carriers configured for the first network entity.
Aspect 52: The method of any of Aspects 47-51, wherein the feedback information is hybrid automatic repeat request (HARQ) information.
Aspect 53: The method of Aspect 52, wherein the feedback information is associated with a HARQ codebook type that has a fixed size.
Aspect 54: The method of Aspect 53, wherein the HARQ codebook type is a Type 1 HARQ acknowledgement codebook.
Aspect 55: The method of any of Aspects 47-54, wherein a size of the feedback information is based on a quantity of downlink time intervals associated with the uplink time interval, as indicated by the slot offset information.
Aspect 56: The method of any of Aspects 47-55, further comprising: receiving a communication indicating one or more slot offsets indicated by the slot offset information, wherein the one or more slot offsets are indicated via a slot offset field, and wherein a size of the slot offset field is based on quantities of slot offsets indicated for the respective downlink time intervals of the one or more downlink time intervals.
Aspect 57: The method of any of Aspects 47-56, further comprising: receiving second slot offset information for a second feedback reporting type.
Aspect 58: A method of wireless communication performed by a first network entity, comprising: transmitting slot offset information for one or more downlink time intervals, wherein the slot offset information indicates one or more uplink time intervals configured for feedback reporting for respective downlink time intervals of the one or more downlink time intervals; and receiving, during an uplink time interval of the one or more uplink time intervals, feedback information for at least one downlink time interval, of the one or more downlink time intervals, indicated by the slot offset information as being associated with the uplink time interval.
Aspect 59: The method of Aspect 58, wherein the slot offset information indicates one or more slot offsets for the respective downlink time intervals of the one or more downlink time intervals, wherein the one or more slot offsets indicate the one or more uplink time intervals.
Aspect 60: The method of any of Aspects 58-59, wherein the slot offset information is periodically updated.
Aspect 61: The method of any of Aspects 58-60, wherein the slot offset information indicates a pattern of slot offsets for the respective downlink time intervals of the one or more downlink time intervals.
Aspect 62: The method of any of Aspects 58-61, wherein the slot offset information is configured for respective downlink carriers configured for the first network entity.
Aspect 63: The method of any of Aspects 58-62, wherein the feedback information is hybrid automatic repeat request (HARQ) information.
Aspect 64: The method of Aspect 63, wherein the feedback information is associated with a HARQ codebook type that has a fixed size.
Aspect 65: The method of Aspect 64, wherein the HARQ codebook type is a Type 1 HARQ acknowledgement codebook.
Aspect 66: The method of any of Aspects 58-65, wherein a size of the feedback information is based on a quantity of downlink time intervals associated with the uplink time interval, as indicated by the slot offset information.
Aspect 67: The method of any of Aspects 58-66, further comprising: transmitting a communication indicating one or more slot offsets indicated by the slot offset information, wherein the one or more slot offsets are indicated via a slot offset field, and wherein a size of the slot offset field is based on quantities of slot offsets indicated for the respective downlink time intervals of the one or more downlink time intervals.
Aspect 68: The method of any of Aspects 58-67, further comprising: transmitting second slot offset information for a second feedback reporting type.
Aspect 69: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-68.
Aspect 70: An apparatus for wireless communication at a device, the apparatus comprising one or more memories and one or more processors coupled to the one or more memories, the one or more processors configured to cause the device to perform the method of one or more of Aspects 1-68.
Aspect 71: An apparatus for wireless communication, the apparatus comprising at least one means for performing the method of one or more of Aspects 1-68.
Aspect 72: A non-transitory computer-readable medium storing code for wireless communication, the code comprising instructions executable by one or more processors to perform the method of one or more of Aspects 1-68.
Aspect 73: A non-transitory computer-readable medium storing a set of instructions for wireless communication, the set of instructions comprising one or more instructions that, when executed by one or more processors of a device, cause the device to perform the method of one or more of Aspects 1-68.
Aspect 74: A device for wireless communication, the device comprising a processing system that includes one or more processors and one or more memories coupled with the one or more processors, the processing system configured to cause the device to perform the method of one or more of Aspects 1-68.
Aspect 75: An apparatus for wireless communication at a device, the apparatus comprising one or more memories and one or more processors coupled to the one or more memories, the one or more processors individually or collectively configured to cause the device to perform the method of one or more of Aspects 1-68.
Aspect 76: A device for wireless communication, the device comprising a processing system, the processing system configured to perform the method of one or more of Aspects 1-68.
Aspect 77: A non-transitory computer-readable medium having code thereon that, when executed by a device, causes the device to perform the method of one or more of Aspects 1-68.

The foregoing disclosure provides illustration and description but is neither exhaustive nor limiting of the scope of this disclosure. For example, various aspects and examples are disclosed herein, but this disclosure is not limited to the precise form in which such aspects and examples are described. Modifications and variations may be made in light of the above disclosure or may be acquired from practice of the aspects.

As used herein, the term “component” shall be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. Systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. As another example, “determining” can include resolving, selecting, obtaining, choosing, establishing, and/or other such similar actions.

Even though particular combinations of features are recited in the claims and/or disclosed in the specification, these combinations do not limit the scope of the disclosure. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As used herein, a phrase referring to “at least one of” a list of items refers to any combination of those items, including single members. As an example, “at least one of: a, b, or c” covers a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” include one or more items and may be used interchangeably with “one or more.” Further, as used herein, the article “the” may include one or more items referenced in connection with the article “the” and may be used interchangeably with “the one or more.” Furthermore, as used herein, the terms “set” and “group” may include one or more items and may be used interchangeably with “one or more.” Where only one item is intended, the phrase “only one” or similar language is used. Also, as used herein, the terms “has,” “have,” “having,” and similar terms are open-ended terms that do not limit an element that they modify (for example, an element “having” A may also have B). Further, the phrase “based on” means “based on or otherwise in association with” unless explicitly stated otherwise. Additionally, as used herein, the phrase “based on” shall not be construed as a reference to a closed set of information, one or more conditions, one or more factors, or the like. Also, as used herein, the term “or” is inclusive when used in a series and may be used interchangeably with “and/or,” unless explicitly stated otherwise (for example, if used in combination with “either” or “only one of”). Further, “one or more” may be equivalent to “at least one.”

Even though particular combinations of features are recited in the claims or disclosed in the specification, these combinations are not limiting of the disclosure of various aspects. Many of these features may be combined in ways not specifically recited in the claims or disclosed in the specification. The disclosure of various aspects includes each dependent claim in combination with every other claim in the claim set.

What is claimed is:

1. A first network entity, comprising:
a processing system configured to:
receive, from a second network entity, first slot offset information and second slot offset information;
receive, from the second network entity, a communication indicating that a feedback communication is to be transmitted during a time interval, wherein the communication indicates that the feedback communication is to be based on the first slot offset information; and
transmit, to the second network entity and during the time interval, the feedback communication, wherein the feedback communication includes feedback information that is based on the first slot offset information.

2. The first network entity of claim 1, wherein the first slot offset information and the second slot offset information are configured for a feedback codebook type having a fixed size, and wherein the feedback communication includes a feedback codebook having the feedback codebook type.

3. The first network entity of claim 1, wherein a size of the feedback communication is based on the first slot offset information.

4. The first network entity of claim 1, wherein the first network entity is configured to communicate via an uplink carrier, and wherein the first slot offset information is configured with respect to a frame structure of the uplink carrier.

5. The first network entity of claim 1, wherein the first network entity is configured to communicate via a downlink carrier, and wherein the first slot offset information is configured with respect to a frame structure of the downlink carrier.

6. The first network entity of claim 1, wherein the processing system, to receive the first slot offset information and the second slot offset information, is configured to:
receive a pattern indicative of the first slot offset information.

7. The first network entity of claim 6, wherein the pattern indicates one or more slot offsets for respective time intervals configured for uplink transmissions.

8. The first network entity of claim 6, wherein the pattern indicates one or more slot offsets for respective time intervals configured for downlink transmissions.

9. The first network entity of claim 6, wherein the pattern is relative to a frame structure of an uplink carrier.

10. The first network entity of claim 6, wherein the pattern is relative to a frame structure of a downlink carrier.

11. The first network entity of claim 1, wherein the communication includes a slot offset field that indicates the first slot offset information.

12. The first network entity of claim 11, wherein the slot offset field is configured to indicate slot offsets indicated by the first slot offset information and the second slot offset information.

13. The first network entity of claim 11, wherein a size of the slot offset field is based on a quantity of uplink time intervals with which respective downlink time intervals are associated, as indicated by the first slot offset information and the second slot offset information.

14. The first network entity of claim 11, wherein a size of the slot offset field is based on one or more sizes of feedback windows indicated by at least one of the first slot offset information or the second slot offset information.

15. The first network entity of claim 11, wherein a size of the slot offset field is based on a quantity of slot offsets indicated by the first slot offset information and the second slot offset information.

16. The first network entity of claim 1, wherein the first slot offset information is associated with a first feedback reporting type, and wherein the second slot offset information is associated with a second feedback reporting type.

17. A first network entity, comprising:
a processing system configured to:
receive slot offset information for one or more downlink time intervals, wherein the slot offset information indicates one or more uplink time intervals configured for feedback
reporting for respective downlink time intervals of the one or more downlink time intervals; and
transmit, during an uplink time interval of the one or more uplink time intervals, feedback information for at least one downlink time interval, of the one or more downlink time intervals, indicated by the slot offset information as being associated with the uplink time interval.

18. The first network entity of claim 17, wherein the slot offset information indicates one or more slot offsets for the respective downlink time intervals of the one or more downlink time intervals, wherein the one or more slot offsets indicate the one or more uplink time intervals.

19. The first network entity of claim 17, wherein the slot offset information is periodically updated.

20. The first network entity of claim 17, wherein the slot offset information indicates a pattern of slot offsets for the respective downlink time intervals of the one or more downlink time intervals.

21. The first network entity of claim 17, wherein the slot offset information is configured for respective downlink carriers configured for the first network entity.

22. The first network entity of claim 21, wherein the feedback information is associated with a HARQ codebook type that has a fixed size.

23. The first network entity of claim 17, wherein a size of the feedback information is based on a quantity of downlink time intervals associated with the uplink time interval, as indicated by the slot offset information.

24. The first network entity of claim 17, wherein the processing system is configured to:
receive a communication indicating one or more slot offsets indicated by the slot offset information, wherein the one or more slot offsets are indicated via a slot offset field, and wherein a size of the slot offset field is based on quantities of slot offsets indicated for the respective downlink time intervals of the one or more downlink time intervals.

25. The first network entity of claim 17, wherein the slot offset information is first slot offset information for a first feedback reporting type, and the processing system is configured to:
receive second slot offset information for a second feedback reporting type.

26. A first network entity, comprising:
a processing system configured to:
transmit, to a second network entity, first slot offset information and second slot offset information;
transmit, to the second network entity, a communication indicating that a feedback communication is to be transmitted during a time interval, wherein the communication indicates that the feedback communication is to be based on the first slot offset information; and
receive, from the second network entity and during the time interval, the feedback communication, wherein the feedback communication includes feedback information that is based on the first slot offset information.

27. The first network entity of claim 26, wherein a size of the feedback communication is based on the first slot offset information.

28. A first network entity, comprising:
a processing system configured to:
transmit slot offset information for one or more downlink time intervals, wherein the slot offset information indicates one or more uplink time intervals configured for feedback reporting for respective downlink time intervals of the one or more downlink time intervals; and
receive, during an uplink time interval of the one or more uplink time intervals, feedback information for at least one downlink time interval, of the one or more downlink time intervals, indicated by the slot offset information as being associated with the uplink time interval.

29. The first network entity of claim 28, wherein the slot offset information indicates one or more slot offsets for the respective downlink time intervals of the one or more downlink time intervals, wherein the one or more slot offsets indicate the one or more uplink time intervals.

30. The first network entity of claim 28, wherein the slot offset information is configured for respective downlink carriers configured by the first network entity.
